(19) United States
(12) Patent Application Publication
(10) Pub. No.: US 2013/0185238 A1
(43) Pub. Date: Jul. 18, 2013

(54) SPLITTING DEVICE, SPLITTING METHOD, AND RECORDING MEDIUM

(71) Applicant: FUJITSU LIMITED, Kawasaki-shi (JP)

(72) Inventors: Hiroaki Morikawa, Kawasaki (JP); Tatsuya Asai, Kawasaki (JP); Shinichiro Tago, Shinagawa (JP); Hiroya Inakoshi, Tama (JP); Nobuhiro Yugami, Minato (JP)

(73) Assignee: FUJITSU LIMITED, Kawasaki-shi (JP)

(21) Appl. No.: 13/738,222

(22) Filed: Jan. 10, 2013

(30) Foreign Application Priority Data
Jan. 18, 2012 (JP) 2012-008533

(51) Int. Cl. G06N 5/04

(52) U.S. Cl. CPC G06N 5/04
USPC 706/45

(57) ABSTRACT

A splitting device includes a memory and a processor configured to execute a program including a procedure. The procedure includes: setting a halt condition with a number of point data points to halt equal splitting as to a target region for equal splitting to split equally; splitting the target region for equal splitting, until the number of point data points in the target region for equal splitting is less than the halt condition, by taking the target region for equal splitting, as a region where a point data group exists; setting a region having point data of a number or more according to the halt condition obtained by performing the splitting, to the target region for equal splitting; performing the uniform splitting regarding each region group having less point data than the number according to the halt condition obtained by performing the splitting.

### CROSS-REFERENCE TO RELATED APPLICATION(S)

This application is based upon and claims the benefit of priority of the prior Japanese Patent Application No. 2012-8533, filed on Jan. 18, 2012, the entire contents of which are incorporated herein by reference.

### FIELD

The embodiment discussed herein is related to a splitting device, a splitting method and a recording medium.

### BACKGROUND

In recent years, collection of point data indicating position has been enabled by the development of Global Positioning System (GPS) equipment. Also, spatial-temporal data processing to gain useful information from the collected point data group has been enabled. For example, as an example of the spatial-temporal data processing, there are optimal region detection, map matching technology, and the like. However, there is a problem in that handling point data groups without change takes much time for processing. Accordingly, when performing sampling processing on point data groups, there is a method to split a point data group into several regions, as one sampling method.

As a conventional method of region splitting, a technique relating to uniform splitting so as to split such that the number of data in the region is uniform, has been disclosed. A circuit splitting device is exemplified, which inputs a circuit diagram and create circuit connection data, and splits these into partial circuits of which the number of clusters is uniform, using a circuit splitting control unit. Japanese Laid-open Patent Publication No. 5-120371 is an example of such related art.

Also, a technique is disclosed relating to equal splitting to split a region equally. A mesh creating device for numerical analysis is exemplified, which repeats splitting of a block equally in coordinate directions according to the coordinate system, using geometric model data which has been obtained by performing modeling on an object for analysis and block splitting of data for block splitting. Japanese Laid-open Patent Publication No. 8-320947 is an example of such related art. A location information transmission device is exemplified, which splits a whole section of information transmission range such as geometric vector data representing road shape and event information, into multiple hierarchical levels and performs section definition so that data amount in each section is about the same. Japanese Laid-open Patent Publication No. 2003-254762 is an example of such related art. Also, there is an area splitting system to perform area splitting on an area including multiple visiting points so that workers may efficiently visit these points. International Publication Pamphlet No. WO 2004/038601 is an example of such related art.

When the uniform splitting occurs as described above, variance in the size of each split region occurs due to making the number of data points in regions uniform. Therefore, some regions may be formed with the longest distance between the point data in the region being longer. There are some cases where such long-formed regions include multiple areas which have to have actual processing. In this way, when the uniformly split regions are over multiple areas which have to have actual processing, data processing of the point data in each area is difficult. For example, in the case of analyzing the number of cases of crimes in a region by areas, an equally split region overlaps different areas A and B, which causes difficult data processing giving attention to each of areas A and B.

On the other hand, when equal splitting has been performed, the region is equally split and the longest distance between point data in the equally split region is shorter than that of the uniformly split region. Thereby, the problem is reduced where a uniformly split region overlaps multiple areas. The equal splitting does not equalize the data number in the region and merely splits multiple regions equally and the number of the point data points in each equally split region is different. Accordingly, even in the event of attempting to provide data processing to equalize service every region, there is difference in service quality allocated to each point data, so service may not be uniform in each region. For example, when crime scenes are taken as point data, and this is to be applied to a plan to place a policeman stationing location in each region, there is imbalance in the number of crimes scenes per region, and the number of cases processed for each policeman stationing location will be different in each region. Therefore, the load regarding policeman stationing locations will differ for each region, leading to disparity in response capabilities.

### SUMMARY

According to an aspect of the invention, a splitting device includes a memory configured to store a program including a procedure and a processor configured to execute the program. The procedure includes: first setting a halt condition with a number of point data points to halt equal splitting as to a target region for equal splitting to split equally, based on a target number of point data points to be included in each region after uniform splitting to split the region, so that the numbers of the point data points indicating locations are uniform, an admissible range percentage indicating an admissible range of the target number, and a greatest uniform splitting number which is a greatest splitting number after uniform splitting when performing uniform splitting of the region so as to satisfy the admissible range percentage; splitting the target region for equal splitting, until the number of point data points in the target region for equal splitting is less than the set halt condition, by taking the target region for equal splitting, as a region where a point data group exists; second setting a region having point data of a number or more according to the halt condition obtained by performing the splitting, to the target region for equal splitting; performing the uniform splitting regarding each region group having less point data than the number according to the halt condition obtained by performing the splitting; and outputting information regarding the split region group.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIGS. 1A, 1B and 1C are explanatory diagram illustrating an example of region splitting processing according to the present embodiment.

FIG. 2 is an explanatory diagram illustrating an example of equal splitting

FIG. 3 is an explanatory diagram illustrating an example of uniform splitting.

FIG. 4 is an explanatory diagram illustrating a distance between the point data in a region.

FIG. 5 is a block diagram illustrating a hardware configuration example of the splitting device according to the present embodiment.

FIG. 6 is an explanatory diagram illustrating an example of storage content of a database.

FIG. 7 is a block diagram illustrating a functional configuration of the splitting device.

FIG. 8 is an explanatory diagram illustrating a relation between an equal splitting halt condition T and a greatest uniform number of slitting k.

FIG. 9 is an explanatory diagram illustrating a relation between an equal splitting halt condition T and a greatest uniform number of slitting k.

FIG. 10 is an explanatory diagram illustrating a relation between an equal splitting halt condition T and a greatest uniform number of slitting k.

FIG. 11 is an explanatory diagram illustrating a determined content example of a splitting number.

FIG. 12 is a flowchart illustrating procedure example of region splitting processing with the splitting device according to the present embodiment.

FIG. 13 is a flowchart describing a detailed processing procedure example of equal splitting sub-routine (step S1206) depicted in FIG. 12.

FIG. 14 is an explanatory diagram illustrating an equal splitting example in step S1306 of FIG. 13.

FIG. 15 is an explanatory diagram illustrating an equal splitting example in step S1307 of FIG. 13.

FIG. 16 is a flowchart describing a detailed processing procedure example of uniform splitting sub-routine (step S1207) depicted in FIG. 12.

FIG. 17 is a flowchart describing a detailed processing procedure of splitting number determining sub-routine (step S1604) depicted in FIG. 16.

FIG. 18 is a flowchart describing a detailed processing procedure of an in-region number-of-data determining sub-routine (step S1605) depicted in FIG. 16.

FIG. 19 is a flowchart describing a detailed processing procedure of parallel splitting sub-routine (step S1606) depicted in FIG. 16.

FIG. 20 is an explanatory diagram illustrating a specific example of region splitting.

FIG. 21 is an explanatory diagram illustrating a specific example of region splitting.

FIG. 22 is an explanatory diagram illustrating a specific example of region splitting.

FIG. 23 is an explanatory diagram illustrating a specific example of region splitting.

FIG. 24 is an explanatory diagram illustrating a specific example of region splitting.

FIG. 25 is an explanatory diagram illustrating a specific example of region splitting.

FIG. 26 is an explanatory diagram illustrating a specific example of region splitting.

FIG. 27 is an explanatory diagram illustrating a specific example of region splitting.

FIG. 28 is an explanatory diagram illustrating a specific example of region splitting.

FIG. 29 is an explanatory diagram illustrating a specific example of region splitting.

FIG. 30 is an explanatory diagram illustrating a specific example of region splitting.

FIG. 31 is an explanatory diagram illustrating a notation example of uniform splitting.

FIG. 32 is an explanatory diagram illustrating a specific example of region splitting.

FIG. 33 is an explanatory diagram illustrating a specific example of region splitting.

FIG. 34 is an explanatory diagram illustrating a specific example of region splitting.

FIG. 35 is an explanatory diagram illustrating a specific example of region splitting.

FIG. 36 is an explanatory diagram illustrating a specific example of region splitting.

FIG. 37 is an explanatory diagram illustrating a specific example of region splitting.

FIG. 38 is an explanatory diagram illustrating a specific example of region splitting.

FIG. 39 is an explanatory diagram illustrating a specific example of region splitting.

FIG. 40 is an explanatory diagram illustrating a specific example of region splitting.

FIG. 41 is an explanatory diagram illustrating a specific example of region splitting.

FIG. 42 is an explanatory diagram illustrating a specific example of region splitting.

FIG. 43 is an explanatory diagram illustrating a specific example of region splitting.

FIG. 44 is a histogram illustrating distribution of point data according to the region splitting result of FIG. 43.

### DESCRIPTION OF EMBODIMENTS

Variance occurs in the number of data in each region by just processing by equal splitting while variance occurs in each area size by just processing by the conventional uniform splitting processing, as with the related art, so making the sizes of multiple regions uniform and making the number of data in each region uniform, will not work.

The present embodiment suppresses the variance in the size of regions produced by uniform splitting, the variance in the number of data for each region produced by equal splitting. Note that in the Present Specification, the term “split” refers to dividing a region into multiple areas, and the term “splitting number” refers to the number of areas into which the region is divided.

The embodiment of a splitting device, splitting method and splitting program will be described below in detail, with reference to attached drawings.

Example of Region Splitting

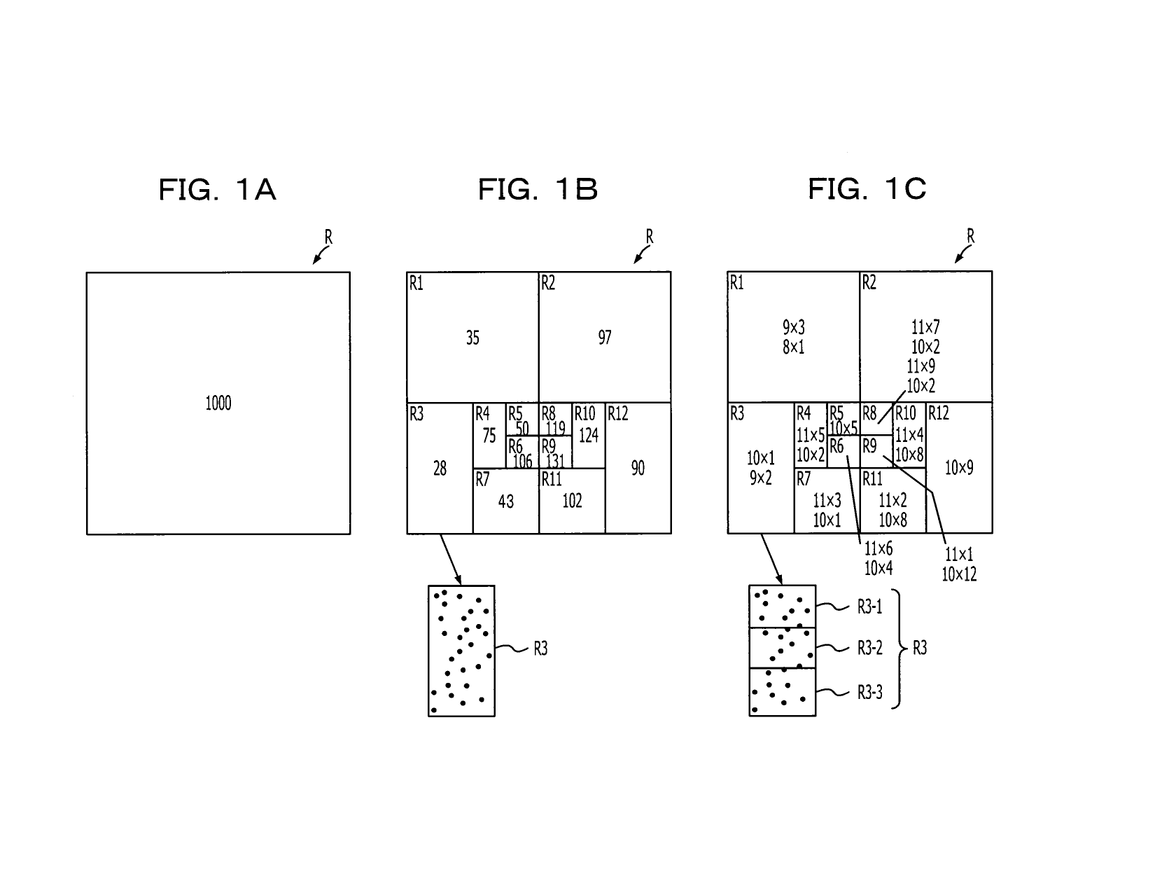

FIGS. 1A, 1B and 1C are diagrams illustrating an example of the region splitting processing according to the present embodiment. FIG. 1A illustrates a state before region splitting performed, FIG. 1B illustrates a state after uniform splitting, and FIG. 1C illustrates a state after equal splitting. In FIGS. 1A and 1B, numeral values in each region indicate the number of point data points. The point data is data with position information of objects for analysis within the regions. Examples as the objects for analysis include, for example, houses, temperature, crime sites, fire sites, observation spots such as base stations of portable terminals, automobiles, and mobile devices such as portable terminals with which people carry.

FIG. 1A illustrates a region R before splitting. As an example, the region R includes 1,000 points of point data. The splitting device equally splits the region R in a state as illustrated in FIG. 1A. The equal splitting is splitting process to equally divide a region. In the present embodiment, equal splitting will be performed until the number of point data points within the regions to be objects for equal splitting is less than that of an equal splitting halt condition. The equal splitting halt condition is an index value to decide whether or not equal splitting will be performed as to the object regions for equal splitting. The equal splitting halt condition is set by a user using target numbers of the point data within the splitting regions. Details of the equal splitting halt condition will be described later. In FIGS. 1A through 1C, the equal splitting halt condition is set to “143” and the object regions for equal splitting is equally split until the numbers of the point data is less than 143.

FIG. 1B illustrates a state after the equal splitting process. In FIG. 1B, let us say that region R is equally split into regions R1 to R12. Numerical values in regions R1 to R12 are the numbers of point data points which exist in each region R1 to R12. For example, there are 28 point data points in region R3. In FIG. 1B, the black points in region R3 indicate point data.

FIG. 1C illustrates a state in which uniform splitting processing has been performed from the state after the equal splitting processing of FIG. 1B. The uniform splitting is splitting processing to divide the number of the point data points so as to be in a uniform manner. There are cases where the number of the point data points is not divisible by an uniform splitting number, so “uniform” includes cases where the number of point data points within the regions which have been subjected to equal splitting is within an admissible range, as opposed to restricting the definition to the same number.

In each region R1 to R12 of FIG. 1C, the notation of “a×b” (a and b are integers) represents that “there are b regions that have a number “a” of point data points”. For example, a region R3 is “10×1, 9×2” and so the region R3 is uniformly split into one region R3-1 where there are ten point data points and two regions R3-2 and R3-3 that both have nine point data points. This also holds regarding regions R1, R2, and R4 to R12, besides region R3.

Thus, the uniform splitting in FIG. 1C is performed in the case that equal splitting is performed as much as possible from the state of FIG. 1A, i.e. until falling below a splitting halt condition, and reaching a state where no more equal splitting is possible (FIG. 1B). Therefore, in the uniformly split regions (e.g., region R3-1 through R3-3) of FIG. 1C, distance between the point data points at both ends in the region becomes shorter compared to the case where uniform splitting has been performed from FIG. 1A, and accordingly the number of the point data points within each region becomes uniform. Therefore, this may be used effectively in data analysis. Note that shape of the region is rectangle but is not limited to a rectangle.

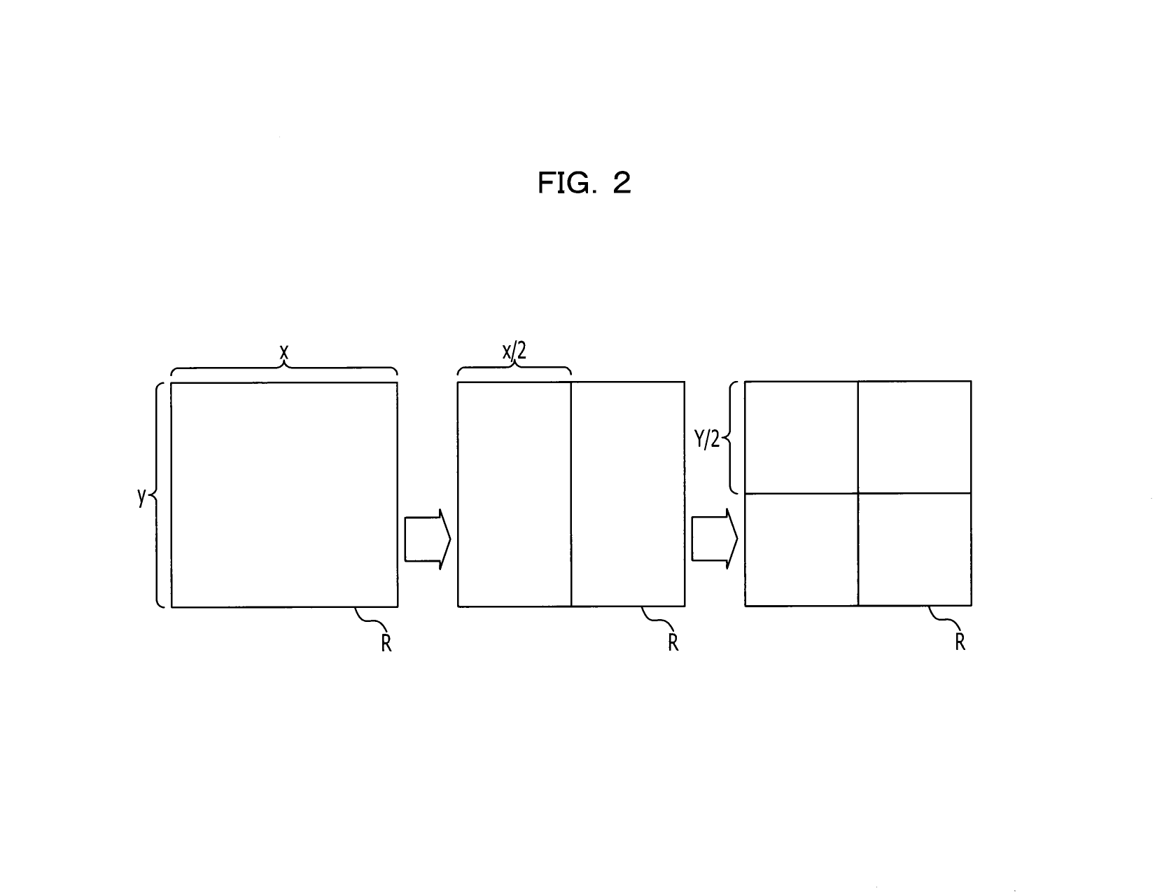

FIG. 2 is an explanatory diagram illustrating an example of equal splitting. With equal splitting, a region R of a horizontal length x and a vertical length y is split from either of x or y, in half. In FIG. 2, first, x is bisected and then, y is bisected. Thereby, region R is split into equal quarters. Note that y may be divided first.

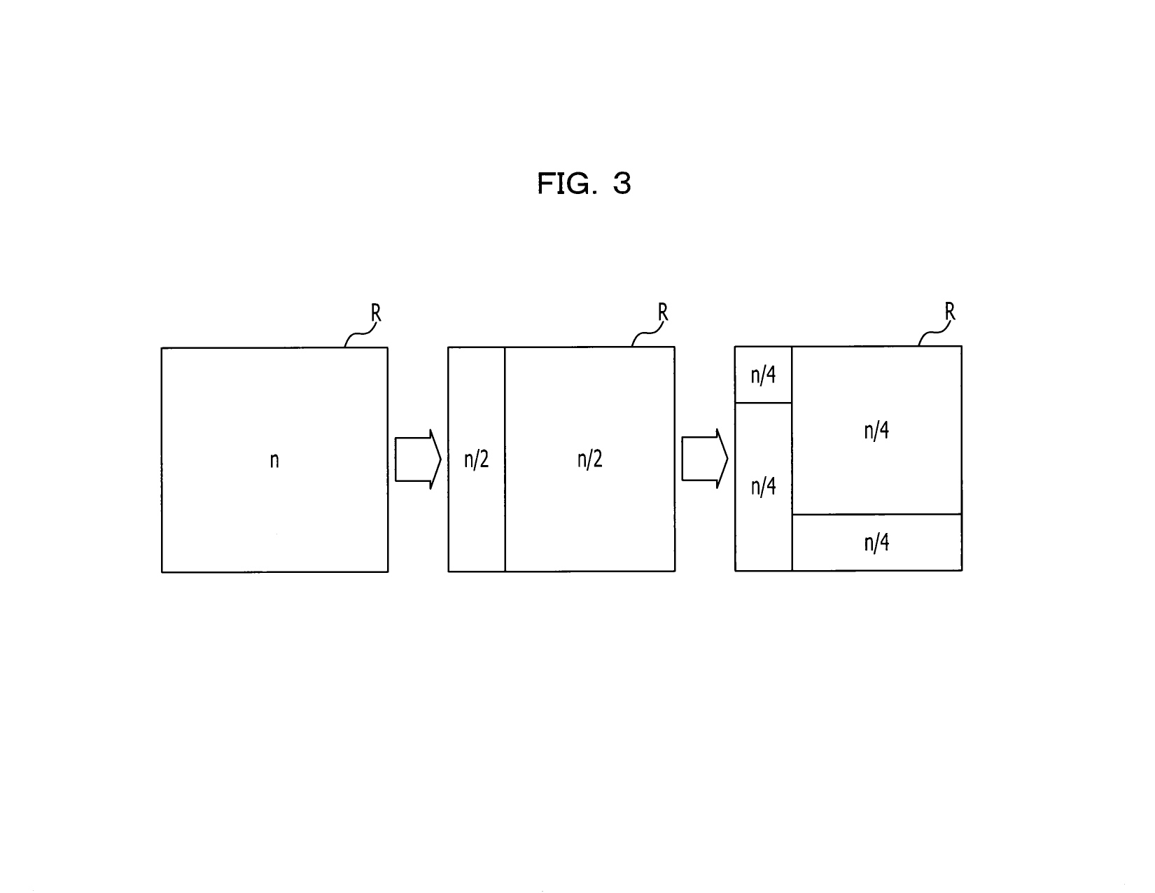

FIG. 3 is an explanatory diagram illustrating an example of uniform splitting. In region R, there are n point data points. With the uniform splitting, regions after splitting are split so as to complete the number of point data points in each region for splitting. For example, region R is split so that the number of point data points becomes n/2 each, and the n/2 regions are split so that the number of point data points becomes n/4 each. Thereby, the number of the point data points in four split regions becomes n/4 each. A region is not divisible in the case that the number of the point data points in the region for splitting is an odd number, so the number of point data points of one of two regions increases (or decreases) by one, regarding the number of point data points in the two regions after splitting.

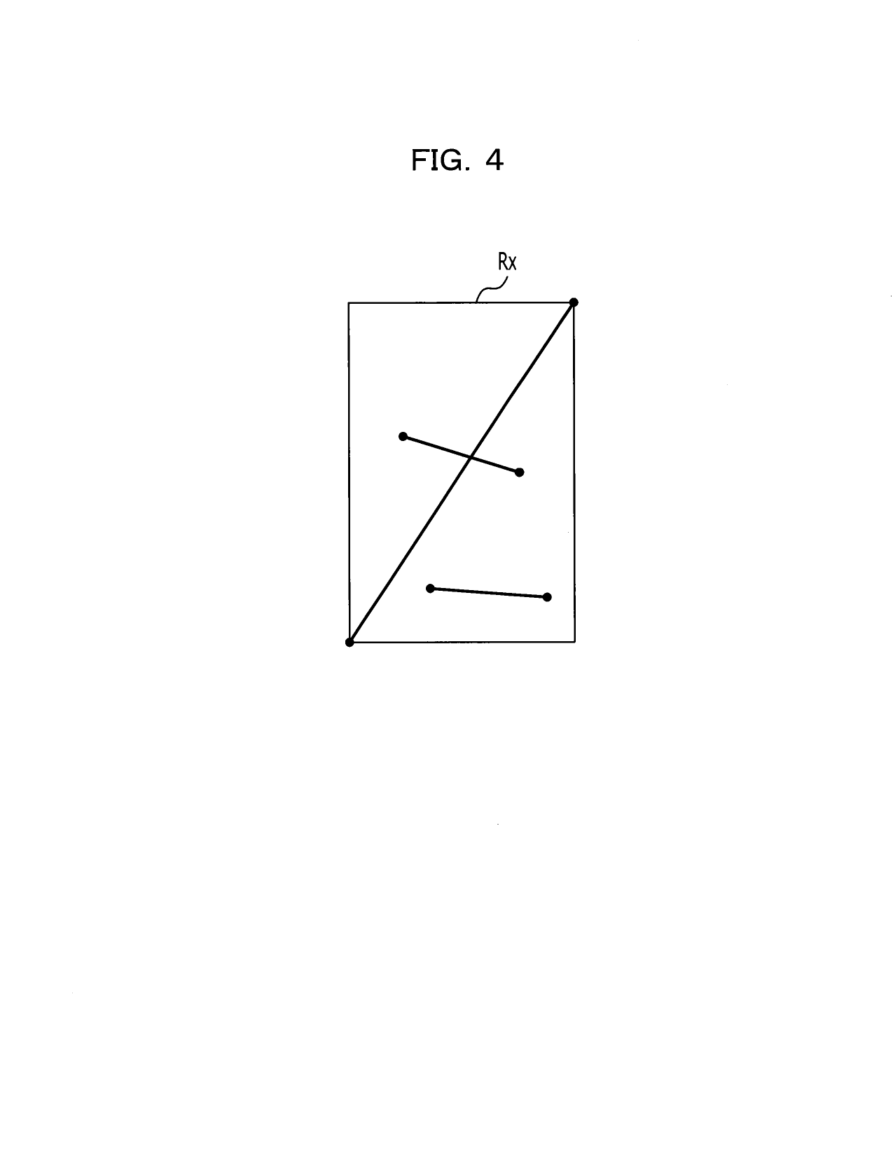

FIG. 4 is an explanatory diagram illustrating a distance between the point data in the region. Region Rx depicted in FIG. 4 is rectangular as an example. The black points in the region Rx depict point data, and the line linking the point data depicts length of the distance between the point data. In the case that the point data points are at vertices of the region Rx being the both ends of the diagonal of the region Rx, the diagonal is the longest distance between the point data. In the region exists in the uniformly split region (e.g., regions R3-1 through R3-3) of FIG. 1C, distance between the point data of both ends in the regions is shorter than the case where uniform splitting is performed directly from the region R, even if the point data points are at vertices of the both ends of the diagonal of the regions. Note that, in FIG. 4, region Rx is assumed to be a rectangle, but when not rectangular, the longest distance between point data may not be a diagonal. For example, when a region is oval, the longest distance between point data is the long axis. Also, when a region is triangular, the longest distance between point data is its longest side.

Hardware Configuration Example of Splitting Device

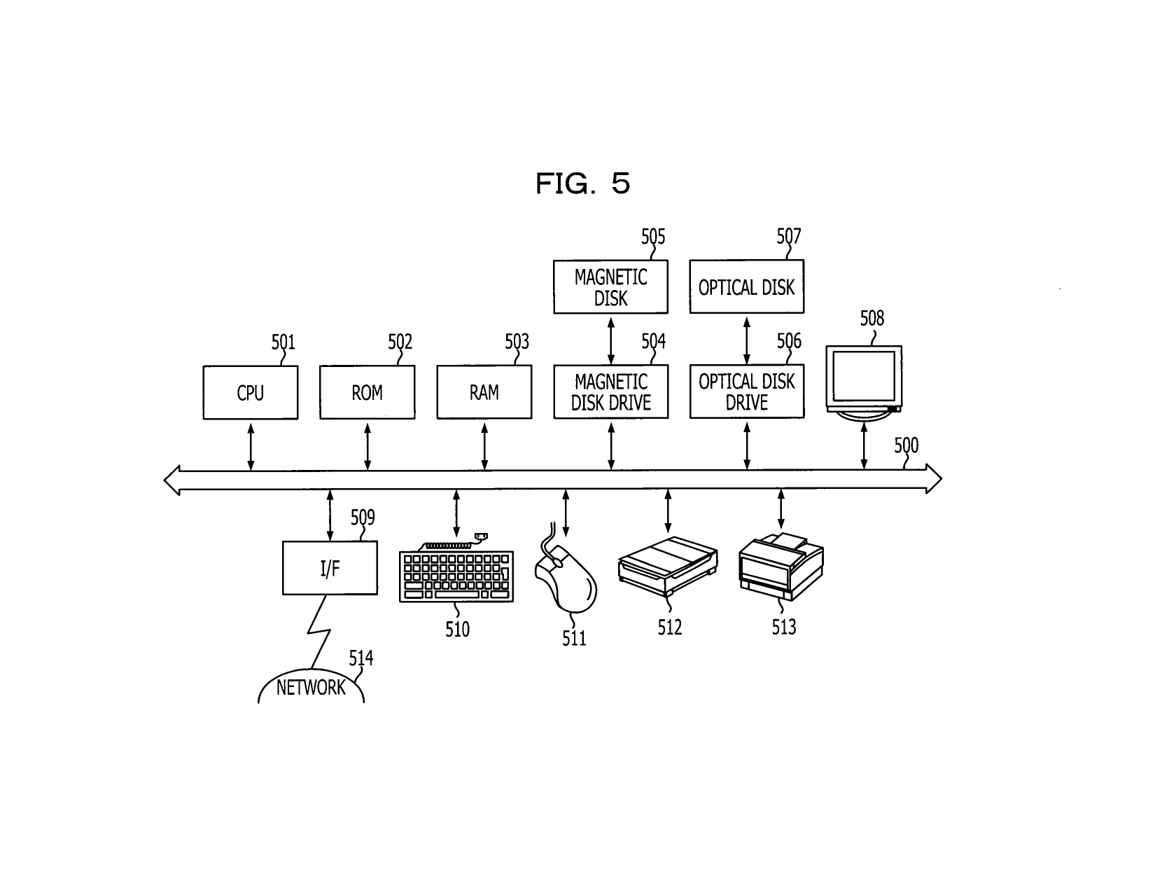

FIG. 5 is a block diagram illustrating a hardware configuration example of a splitting device according to the present embodiment. In FIG. 5, the splitting device includes a CPU (Central Processing Unit) 501, a ROM (Read Only Memory) 502, a RAM (Random Access Memory) 503, a magnetic disk drive 504, a magnetic disk 505, an optical disc drive 506, an optical disc 507, a display 508, an I/F (Interface) 509, a keyboard 510, a mouse 511, a scanner 512, and a printer 513. Also, the components are connected by a bus 500.

Here, the CPU 501 controls the splitting device. The ROM 502 stores the programs such as boot programs. The RAM 503 is used as a working area for the CPU 501. The magnetic disk drive 504 controls the read/write of data to the magnetic disk 505 according to control of the CPU 501. The magnetic disk 505 stores data written in by control of the disk drive 504.

The optical disc drive 506 controls the read/write of data from/to the optical disc 507 according to control of the CPU 501. The optical disc 507 stores data written under control of the optical disc drive 506 and allows a computer to read data stored in the optical disc 507.

The display 508 displays data such as a document, image, and function information including a cursor, an icon or a tool box. For example, this display 508 may adopt a liquid-crystal display, plasma display or the like.

The interface (hereinafter, referred to as “I/F”) 509 is connected to the network 514 such as a LAN (Local Area Network), WAN (Wide Area Network), the Internet, or the like, through telecommunication lines, and is connected to other devices through this network 514. The I/F 509 controls between an internal interface and the network 514 and controls input-output of data from external device. A modem or an LAN adapter may be adapted as the I/F 509, for example.

The keyboard 510 includes keys for input such as text, numbers, and various instructions, and performs data input. This keyboard 510 may be an input pad or a touch-panel numerical keypad. The mouse 511 performs motion or range selection of the cursor, or movement of a window or change of size thereof. A trackball or a joy-stick may be also employed as long as having similar functions as a pointing device.

The scanner 512 optically reads off image and captures the image data in the splitting device. Note that, the scanner 512 may have an OCR (Optical Character Reader) function. Also, the printer 513 prints image data and document data. For example, a laser beam printer and an ink-jet printer can be adopted as the printer 513. Note that, at least any of the optical disc drive 506, optical disc 507, display 508, keyboard 510, mouse 511, scanner 512, and printer 513 may be omitted.

Example of Storage Content of Database

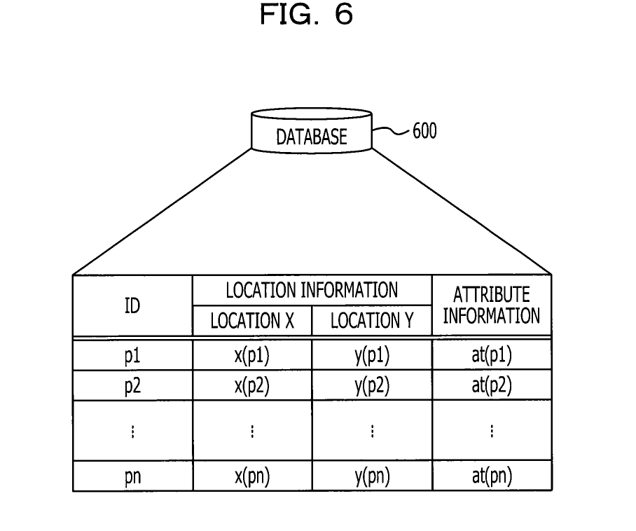

FIG. 6 is an explanatory diagram illustrating an example of storage content of a database (hereinafter also referred to simply as “DB” (DataBase)). A DB 600 stores point data groups to be an object for analysis. The DB 600 has an ID item, a position information item, and an attribute information item, and has values of each item in point data. Identifiers p1, p2 and so on through pn identifying point data points are stored in the ID item. The position information item has position X items indicating position coordinates in the X direction and position Y items indicating position coordinates in the Y-direction. X-coordinate values x (p1), x (p2) through x (pn) of point data on region data are stored in the position X items. Y-coordinate values y (p1), y (p2) through y (pn) of point data on region data are stored in the position Y items. An administrator of the DB 600 may manually input and may also be uploaded via a network from a computer to be an object for analysis corresponding to the point data, regarding acquisition of position information. For example, in the case of an automobile and a portable terminal, position information which has been obtained by GPS may be received by the splitting device and may be stored in the DB 600.

Attribute values at (p1), at (p2), and so on through at (pn) according to attribute information are stored in the attribute information items. Attribute information is information indicating characteristics of the point data and, for example, in the case of the point data being an observation spot, temperature, the number of crime scenes and fire outbreaks, or the like are exemplified. Also, in the case of the point data indicating houses, the amount of electric power used, the number of people living in each house, and so forth, are exemplified. Also, in the case of the point data being an automobile, the type of car, CO₂ emission, and the like are exemplified. Also, in the case of the point data being a portable terminal, battery charge and the like are exemplified. Note that, an administrator of the DB 600 may manually input and may also be uploaded from a computer to be an object for analysis corresponding to the point data, regarding acquisition of attribute information. Also, while not illustrated, region data in which there is a point data group, is stored in the DB 600. The region data is, for example, region vertex coordinates.

Functional Configuration Example of Splitting Device

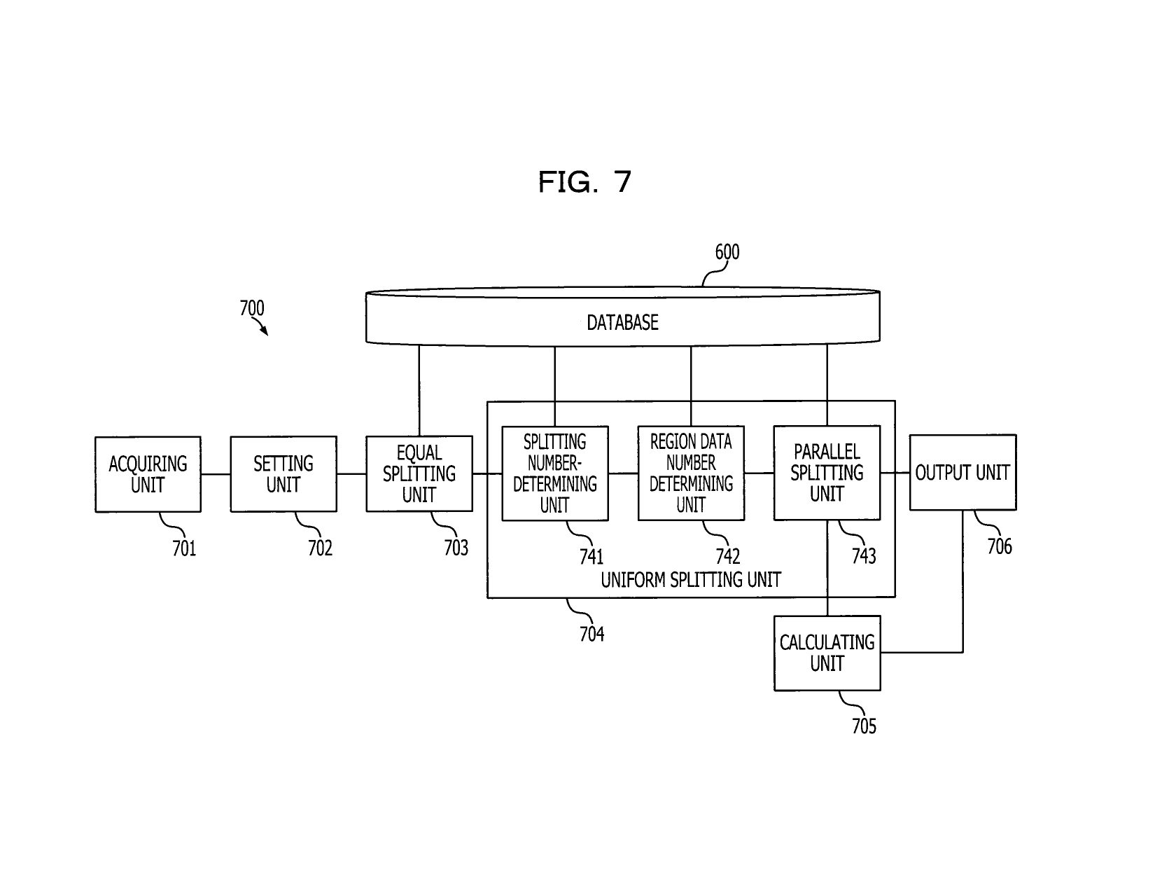

FIG. 7 is a block diagram illustrating a functional configuration of a splitting device. The splitting device 700 has an acquiring unit 701, a setting unit 702, an equal splitting unit 703, a uniform splitting unit 704, a calculating unit 705, and an output unit 706. The acquiring unit 701, setting unit 702, equal splitting unit 703, uniform splitting unit 704, calculating unit 705, and output unit 706 realizes the functions by causing the CPU 501 to execute a program stored in a storage device such as the ROM 502, RAM 503, magnetic disk 505, and optical disc 507 depicted in FIG. 5 for example, or by the I/F 509.

The acquiring unit 701 acquires various parameters, specifically, region data to be divided such as geographic data, for example. Also, the acquiring unit 701 acquires target number c and admissible range percentage m. The target number c is the number of the point data points to be included in each uniformly split region. Specifically, target number c is the number of the point data points in the splitting region which a user requests. For example, in the case that the number of the point data points in the splitting region is desired to be 100, this is c=100. Also, the admissible range percentage m is a percentage to determine an admissible percentage of difference between actual numbers of the point data in the splitting region obtained by the splitting device 700 and target number c. For example, in the case of desiring to divide into a region which finally holds one hundred point data points, (c=100), when the admissible range percentage m is m=10%, generating of regions is permitted such that the number of the point data points is between 90 to 110. The value area of the admissible range percentage is 0≦m≦1.

Also, acquiring unit 701 may obtain a matching percentage r. The matching percentage r is a percentage indicating the number of regions holding the number of point data points satisfying admissible range percentage m in the number of all split regions. For example, if we say that the number of all split regions is 1,200 and the number of the regions fitting into the number of point data points satisfying admissible range percentage m among them is 900, the matching percentage is 900/1200=75%. The value area of the matching percentage r is 0≦r<1. Specifically, acquiring unit 701 acquires various parameters, for example, by a user operating the keyboard 510 and mouse 511. Also, the acquiring unit 701 acquires various parameters from the I/F 509.

The setting unit 702 sets an equal splitting halt condition based on target number c, admissible range percentage m, and greatest number of uniform splitting k which is the greatest number of uniform splitting after uniform splitting in the case of performing equal splitting so as to satisfy the admissible range percentage m. The equal splitting halt condition is an index value to whether or not performing equal splitting, to an object region for equal splitting. When equally split regions are uniformly split by the greatest number of uniform splitting k, the equally split regions are uniformly split so as to satisfy the admissible range percentage m.

The equal splitting halt condition is the number of point data points generating a region so as to be as short as possible the longest distance between the point data in the region, by performing equal splitting. That is to say, a region having the number of point data points below an equal splitting halt condition indicates that the longest distance of the point data in the region is short capable of performing equal splitting. The region having the number of point data points above an equal splitting halt condition is equally split until it is below the equal splitting halt condition. The setting unit 702 calculates equal splitting halt condition T using target number c and admissible range percentage m.

The equal splitting halt condition T is defined using target number c and admissible range percentage m by the following Expression (1).

T=k(1+m)c (1)

The greatest number of uniform splitting k is an integer to satisfy k≧1. Here, a relation with equal splitting halt condition T and greatest number of uniform splitting k will be described.

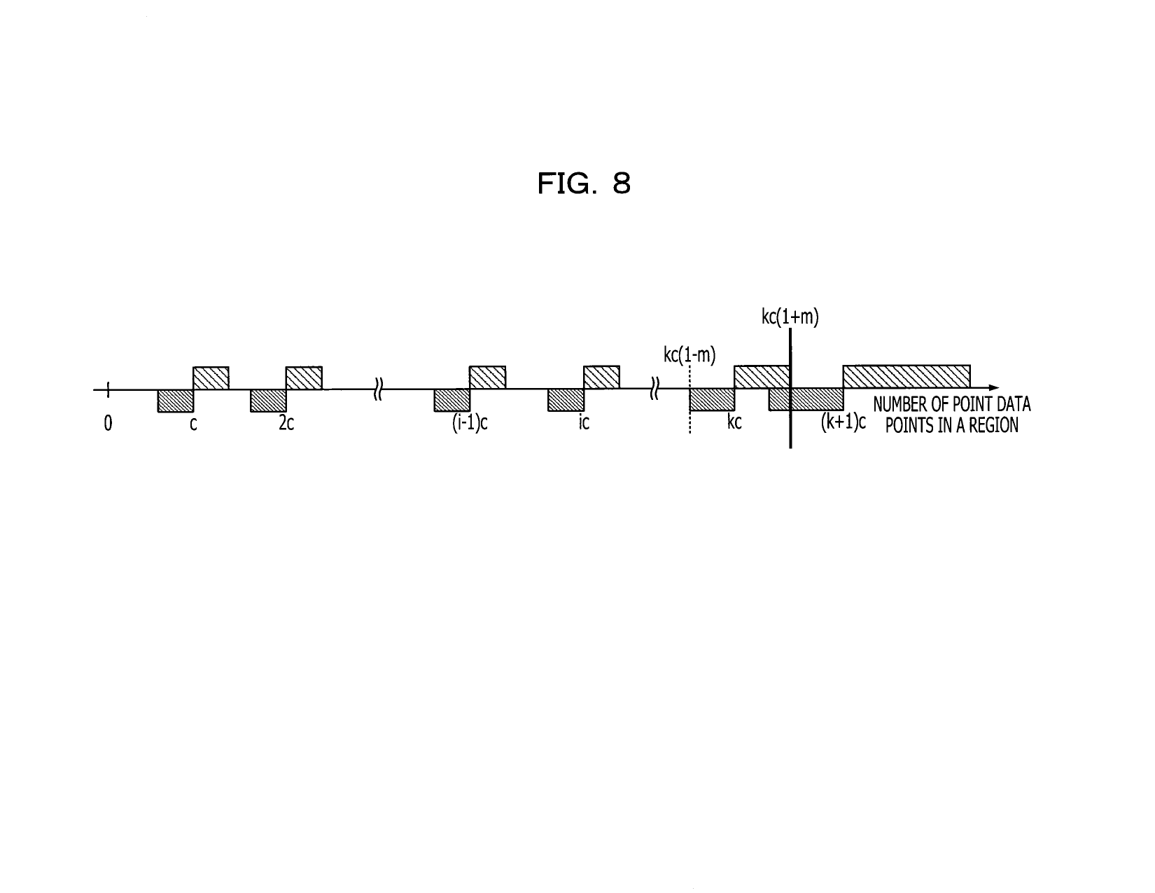

FIGS. 8 through 10 are explanatory diagram illustrating a relation with equal splitting halt condition T and greatest number of uniform splitting k. In FIG. 8, the number line depicts the number of the point data points in the region. On the assumption that equal splitting is stopped around a double constant of the target number c, the number of the point data points in the region when the equal splitting stopped is taken as x. When satisfying the following Expression (2), the splitting device 700 may perform uniform splitting so as to satisfy the admissible range percentage m, by performing k splits on a region.

kc(1−m)≦x≦kc(1+m) (2)

The probability that splitting to satisfy the admissible range percentage m at the time of T=kc(1+m) becomes highest near kc. Thus, as the equal splitting halt condition T=kc(1+m) of the above Expression (1) is adopted. The maximum equal splitting number k in a case where equal splitting halt condition T is used to perform equal splitting as much as possible, and a region is generated where the distance between two points in the region is as close as possible, is defined by the following Expression (3).

k=(1−m)/2m (3)

Substituting the greatest number of uniform splitting k of the above Expression (3) into the above Expression (1), yields the following.

T={(1−m)/2m}(1+m)c (4)

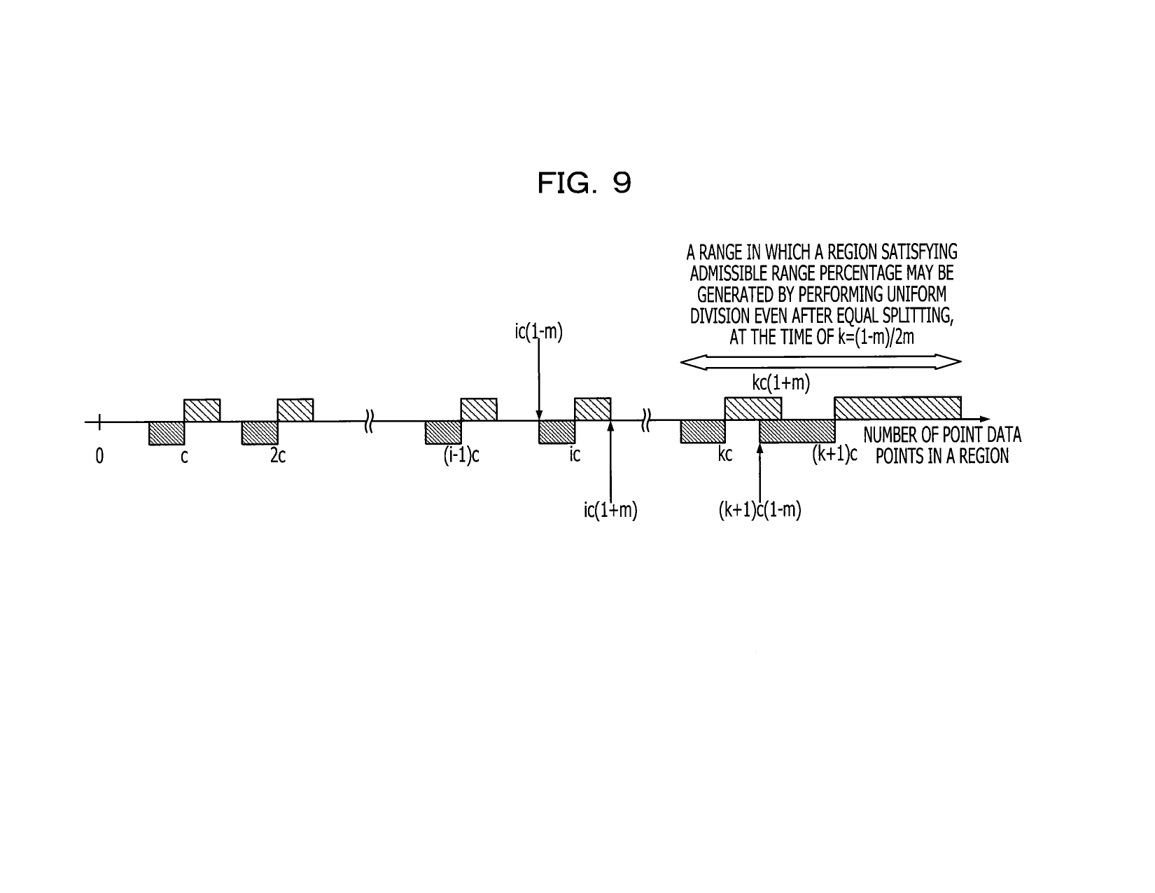

In FIG. 9, when kc(1+m)≧(k+1)c(1−m) is satisfied, i.e., when the admissible range around kc overlaps the admissible range around (k+1)c, the region of the number of the point data x points is uniformly split into regions which satisfy admissible range percentage m at all times. Therefore, when kc(1+m)≧(k+1)c(1−m) is solved regarding greatest number of uniform splitting k this time, the greatest number of uniform splitting k is represented by the following Expression (5).

k≧(1−m)/2m (5)

Note that k is an integer and decimal places are rounded up. Therefore, when satisfying Expression (5), in FIG. 9, equal splitting halt condition T in the range of kc(1−m) to (k+1)c(1+m) indicated by a heavy arrow will generate a region which satisfies the admissible range percentage m by performing uniform splitting even if equal splitting has been performed.

For example, in the case that admissible range percentage m is m=0.1 and target number c is c=10, substituting into Expression (5) yields that the greatest number of uniform splitting k is k≧5. Here, by substituting k=5 into Expression (1), the equal splitting halt condition T is 5×10×(1+0.1)=55. That is to say, in the case of the number of the point data points in the object region for equal splitting being greater than or equal to 55, the object region is equally split, and in the case of the number of the point data points in the object region for equal splitting being less than 55, the object region is not split any more.

Note that the greatest number of uniform splitting k is an integer of k≧5, an integer greater than five may be taken for k. However, the greater the greatest number of uniform splitting k is, the greater the equal splitting halt condition T also is, and accordingly in the case of desiring to increase the number of regions, it is preferable to set k as small as possible. For example, in the case of k≧5, k=5 is preferable.

Also, in the case that matching percentage r is acquired by the acquiring unit 701, the greatest number of uniform splitting k and equal splitting halt condition T are defined by the following Expressions (6) and (7).

k=1/{4m(1−r)} (6)

T=[1/{4m(1−r)}]×(1+m)×c (7)

The matching percentage r is a value which is acquired beforehand, but on the assumption that the number of point data points in the region regarding which equal splitting has been performed by region splitting is the same, the following Expression (8) holds regarding the matching percentage r.

$$r = \frac{{\sum }_{i = 0}^{{k}^{′}} \{ ic ( 1 + m ) - ic ( 1 - m ) \} + \{ kc ( 1 + m ) - {k}^{′} c ( 1 + m ) \}}{kc ( 1 + m )} \qquad ( 8 )$$

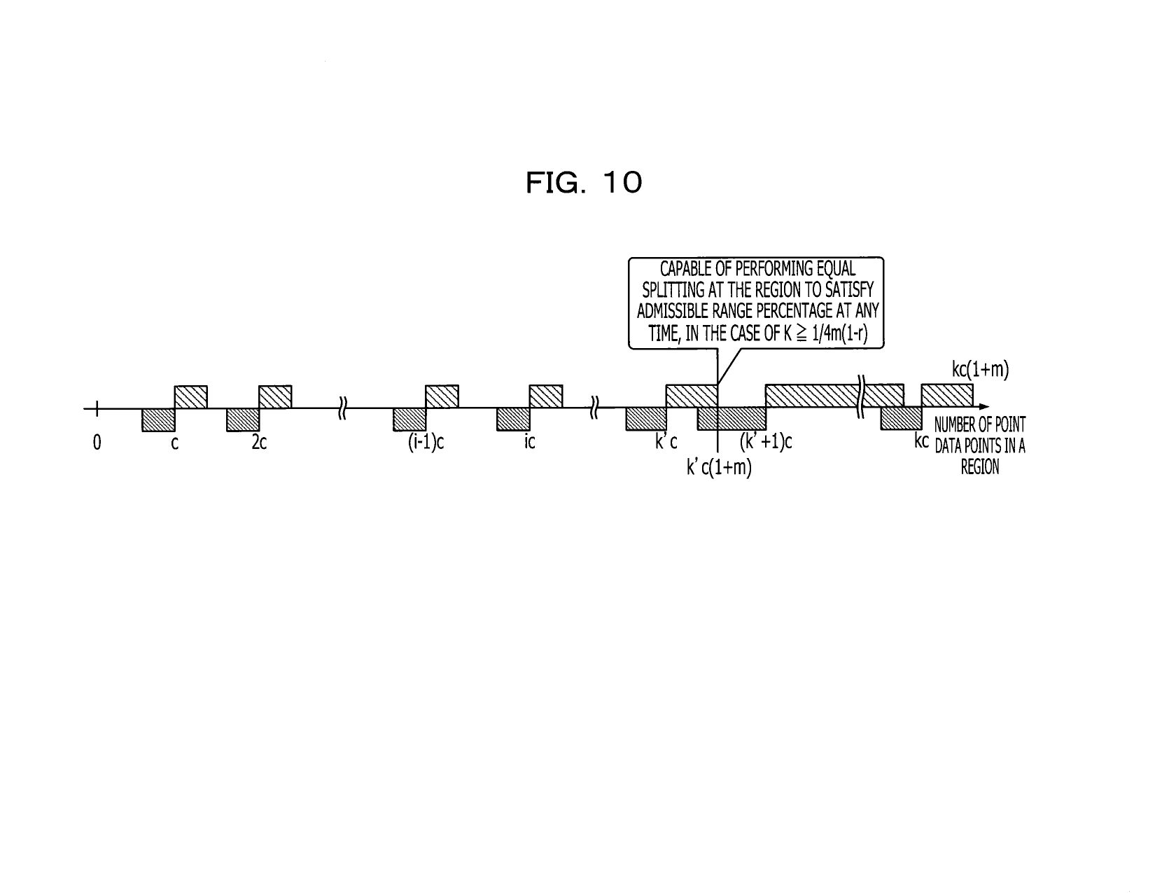

As depicted in FIG. 10, we will say that k′ is a variable where k′≧(1−m)/2m. The denominator of Expression (8) is the number of point data points kc(1+m) which is the upper limit of admissible range percentage m in the case of the number of point data points in the region being kc. The first term of numerator Expression (8) is the total sum of the admissible range when the number of the point data points in the region which range is from i=1 through k′ is ic. The second term of numerator indicates a range from number k′c(1+m) to kc(1+m) which is the upper limit of the admissible range at i=k′. That is to say, the numerator value is the total sum of all admissible ranges in FIG. 10.

When substituting k′≧(1−m)/2m into Expression (8) and solving the greatest number of uniform splitting k, the following Expression (9) is provided.

k≧1/{4m(1−r)} (9)

Note that k is an integer and decimal places are rounded up. For example, in the case of admissible range percentage m being m=0.1, target number c being c=10, matching percentage r being r=0.8, k=12.5 holds and k=13 holds true by rounding up. Therefore, the equal splitting halt condition T=([1/{4×0.1×(1−0.8)}]×(1+0.1))×10=137.5, which is approximately 138. That is to say, in the case of the number of the point data points in the object region for equal splitting being greater than or equal to 138, the object region is equally split, and in the case of the number of the point data points in the object region for equal splitting being less than 138, the object region is not split any more.

Thus, the setting unit 702 calculates equal splitting halt condition T by Expression (4) when target number c and admissible range percentage m are acquired, and matching percentage r is not acquired. Also, the setting unit 702 calculates equal splitting halt condition T by Expression (7) when target number c, admissible range percentage m and matching percentage r are acquired.

Referring back to FIG. 7, the equal splitting unit 703 equally splits an object region for equal splitting until it is below the equal splitting halt condition T set by the setting unit 702. Specifically, for example, the equal splitting unit 703 acquires a region including point data group p1-pn and the point data group from the DB 600. The equal splitting unit 703 selects then each of the regions as an object region for equal splitting and detects the number of the point data points in the object region. The equal splitting unit 703 compares the detected number and the equal splitting halt condition T and when the detected number is below the equal splitting halt condition T, does not perform equal splitting of the object region. On the other hand, if the detected number is above the equal splitting halt condition T, the equal splitting unit 703 performs equal splitting for the object region.

Also, when performing equal splitting on an object region, the equal splitting unit 703 preferably divides the longest side of the object region equally. For example, splitting a longer side in half rather than splitting a shorter side results a shorter diagonal of the region after splitting, which shortens the longest distance between the point data. Therefore, this may reduce occurrences of forming a shape where a split region overlaps a different area, thereby obtaining an easy-to-use region for analysis.

The uniform splitting unit 704 performs uniform splitting to split so that the number of the point data points becomes uniform regarding each of region groups having point data of which numbers are less than the equal splitting halt condition T obtained by the equal splitting unit 703. Specifically, for example, the uniform splitting unit 704 has a splitting number determining unit 741, a data number determining unit 742, and a parallel determining unit 743. The splitting number determining unit 741 determines splitting number regarding each region split by the equal splitting unit 703. Specifically, for example, the splitting number determining unit 741 sets the integer i to the splitting number of uniform splitting splitNum, in the case of the number of point data points in the regions being a number within a section [ic(1−m), ic(1+m)] defined by the admissible range percentage m based on an integral multiple of the target number c, regarding the regions of a region group obtained by the equal splitting unit 704.

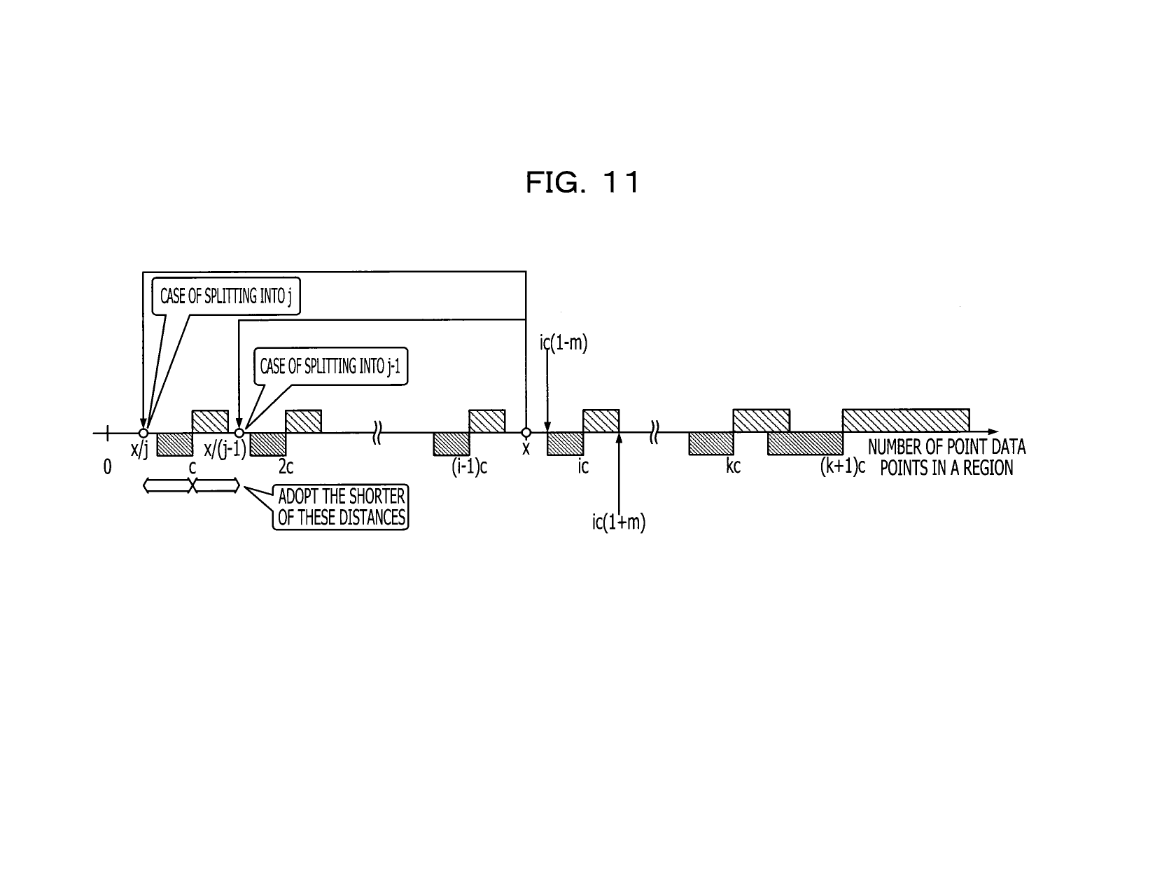

FIG. 11 is an explanatory diagram illustrating a determined content example of the splitting number. When the number of point data in the region after equal splitting satisfies admissible range percentage m, the splitting number determining unit 741 determines splitting number splitNum to integers (more than 1) which is greatest number of equal splittings k or less. Thereby, the uniform splitting unit 704 may perform uniform splitting on the equally split region so as to be k at most. On the other hand, in the case of the number of point data in the region after equal splitting not entering the region satisfying admissible range percentage m, the splitting number determining unit 741 determines splitting number splitNum using the following Expression (10).

L={2j(j−1)/(2j−1)}×c (10)

The splitting number determining unit 741 takes L of Expression (10) as a threshold and performs j splitting when the number of point data points in the region after equal splitting is above L, and performs (j−1) splitting when the number of point data points in the region after equal splitting is below L. Let us say that the number of point data points in the region to split is x. Regarding the region before uniform splitting not entering the range where number x satisfies admissible range percentage m, uniform splitting is performed so that the number of the point data points of the region after the uniform splitting approximates to the number of the range that satisfies admissible range percentage m as much as possible. At this time, which of j splitting and (j−1) splitting enables the number of point data points in the region split by uniform splitting, to approximate to a target number c, is considered.

That is to say, the number of the point data points in the case of performing j splitting on the number of x point data points is x/j, and the number of the point data points in the case of performing (j−1) splitting on the number of x points of point data is x/(j−1). Also, the distance from x/j to the target number c is set to (c−x/1) and the distance from the target number c to x/(j−1) is set to {x/(j−1)}−c, and of these, the shorter distance is close to the target number c. Therefore, the following Expression (11) is obtained when obtaining x in the case of both distances being equal.

x={2j(j−1)/(2j−1)}×c (11)

Expression (10) is provided by taking Expression (11) as a threshold. That is, in the case of the number of the point data points within the region after the equal splitting exceeding L, j splitting approximates the number of point data points after the uniform splitting to the target number c. Therefore, splitting number splitNum is determined by j. Also, in the case of the number of the point data points within the region after the equal splitting not exceeding L, (j−1) splitting approximates the number of point data points after the uniform splitting to the target number c. Therefore, the splitting number splitNum is determined by (j−1).

The region data number determining unit 742 determines the number of the point data points in the regions which obtained by performing uniform splitting on the target region for uniform splitting by the splitting number splitNum, based on the division result obtained by dividing the number of the point data points which the target region for uniform splitting has by the splitting number splitNum, so that the difference of the numbers is minimized. The split regions split by the equal splitting unit 703 is subjected to uniform splitting, by the number of splitting determined in each region split by the equal splitting unit 703. If we say the number of the point data points in the equally split region is Aₙᵤₘ, the number of the point data points after the uniform splitting is obtained by Aₙᵤₘ/splitNum. For example, in FIG. 1B, the region R3 having 28 point data points is performed three-splitting so as to be the same number of the point data points. That is to say, the number of the point data points in the regions after the uniform splitting of the region R3 is Aₙᵤₘ/splitNum=28/3 which is approximately 9.3.

However, since the number of point data points is an integer, the number of the point data points in the regions after the uniform splitting is modified using the binary values of the minimum value with the decimal places rounded down and the maximum value with the decimal places rounded up. For example, the number of the point data points in the regions after the uniform splitting of the region R3 of the above-described FIG. 1 is Aₙᵤₘ/splitNum=28/3 which is approximately 9.3, so that the minimum value is 9 and the maximum value is 10.

The region data number determining unit 742 generates a set with minimum values of a number equivalent to the splitting number splitNum arrayed. In the case of the region R3, the set is {9, 9, 9}. When the sum of the number of the point data points in the set is different from Aₙᵤₘ, the region data number determining unit 742 converts the minimum value in the set into a maximum value. For example, in the case of set {9, 9, 9} of region R3, this is converted into set {9, 9, 10}. The region data number determining unit 742 performs obtains the sum for the set after conversion in the same way, and performs comparison with Aₙᵤₘ. In the case of set {9, 9, 10} of region R3, the sum is 28 which equals Aₙᵤₘ. Therefore, the regions uniformly split from the region R3 is two regions including one region including ten point data points and two regions including nine point data points.

The parallel splitting unit 743 splits the equally split region in a parallel manner so as to be the number of the data points in the region determined by the region data number determining unit 742. In the case of the region R3 of the above example, this is split into the region R3-1 including 10 point data points, and regions R3-2 and R3-3 both including 9 point data points.

The calculating unit 705 calculates actual matching percentage rd, based on the number of regions in the region group split by the uniform splitting unit 704 and, of region groups split by the uniform splitting unit 704, the number of regions where the number of the point data points satisfies admissible range percentage m. The match percentage rd is a value obtained by dividing the number of regions within the number of point data points satisfying admissible range percentage m, by the number of the total regions after the region splitting by the equal splitting unit 704. In the case of FIG. 1C, the number of the regions within the number of point data satisfying admissible range percentage m is 96, and the number of the total regions after the region splitting by the equal splitting unit 704 is 97. Therefore, the calculating unit 705 calculates 96/97=99% as actual matching percentage rd.

The output unit 706 outputs a region splitting result by the uniform splitting unit 704. Specifically, for example, a region splitting result depicted in FIG. 1C is output. Also, when the matching percentage r is input, the output unit 706 outputs a matching percentage rd calculated by the matching percentage r and the calculating unit 705. The user can grasp whether or not the matching percentage r has been an appropriate value by outputting the matching percentage s r and rd. In the case of being r<rd, this is appropriate splitting and in the case of not being r<rd, the matching percentage r has not been an appropriate value. Therefore, users may change the matching percentage r and may perform splitting again. Note that, as for the output form, there are display to the display 508, a printout to the printer 513, sending to other devices, and storing in the storage device in the splitting device 700.

Region Splitting Processing Example

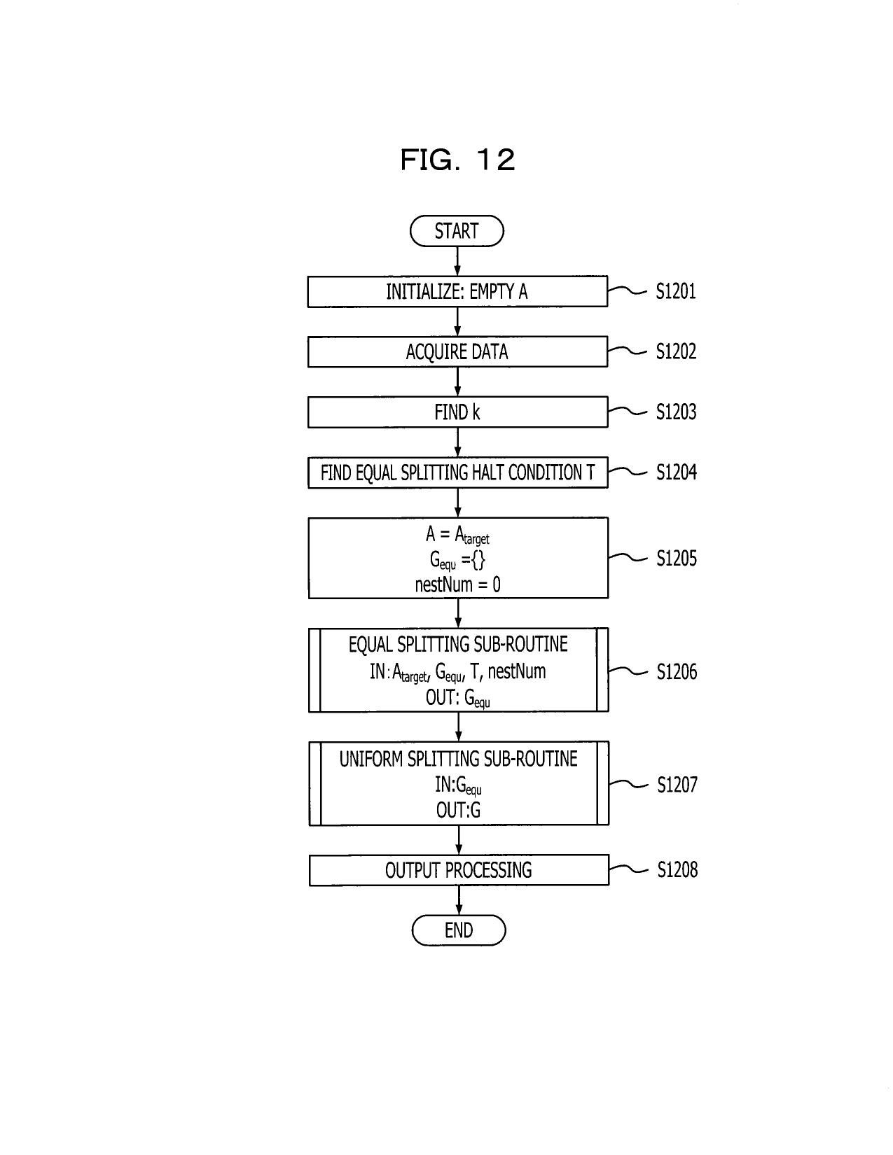

FIG. 12 is a flowchart describing a region splitting processing example with the splitting device 700 according to the present embodiment. First, the splitting device 700 empties region A by initialization (step S1201). The splitting device 700 then acquires various data by the acquiring unit 701 (step S1202). For example, the various data is region data to be targeted for splitting, a target number c, an admissible range percentage m, and a matching percentage r.

The splitting device 700 then calculates a greatest number of uniform splitting k by the setting unit 702 (step S1203). Specifically, for example, the splitting device 700 calculates a greatest number of uniform splitting k by the above Expression (3) when an admissible range percentage m is acquired. Also, the splitting device 700 calculates a greatest number of uniform splitting k by the above Expression (6) when an admissible range percentage m and matching percentage r are acquired.

And the splitting device 700 provides the greatest number of uniform splitting k, target number c, admissible range percentage m calculated by the setting unit 702 for the Expression (1), and calculates equal splitting halt condition T (step S1204). The splitting device 700 then sets A=A_{target}, G_{equ} to G_{equ}={ }, and nestNum=0 in region A (step S1205). A_{target} is a rectangular region to be targeted for splitting. G_{equ} is a set of regions after splitting. At present, this is an empty set. NestNum is number of times for equal splitting and is incremented every time the equal splitting is performed. When the nestNum is beyond threshold maxNestNum, region splitting satisfying the matching percentage r is not made and an error output is made.

The splitting device 700 then performs equal splitting sub-routine by the equal splitting unit 703 (step S1206), and then performs the equal splitting sub-routine regarding region groups equally split by the equal splitting unit 704 (step S1207). Input in the equal splitting sub-routine (step S1206) is the region A_{target} to be targeted for splitting, region set G_{equ} before equal splitting, equal splitting halt condition T, and number of times for equal splitting nestNum. Output in the equal splitting sub-routine (step S1206) is region set G_{equ} after the equal splitting. Also, input in the uniform splitting sub-routine (step S1207) is region set G_{equ} after the equal splitting. Output in the uniform splitting sub-routine (step S1207) is uniformly split region set G.

Finally, the splitting device 700 outputs uniformly split region set G by the output unit 706 (step S1208). Note that, the splitting device 700 calculates a matching percentage rd by the calculating unit 705 using set G prior to output, and may output the calculated matching percentage rd.

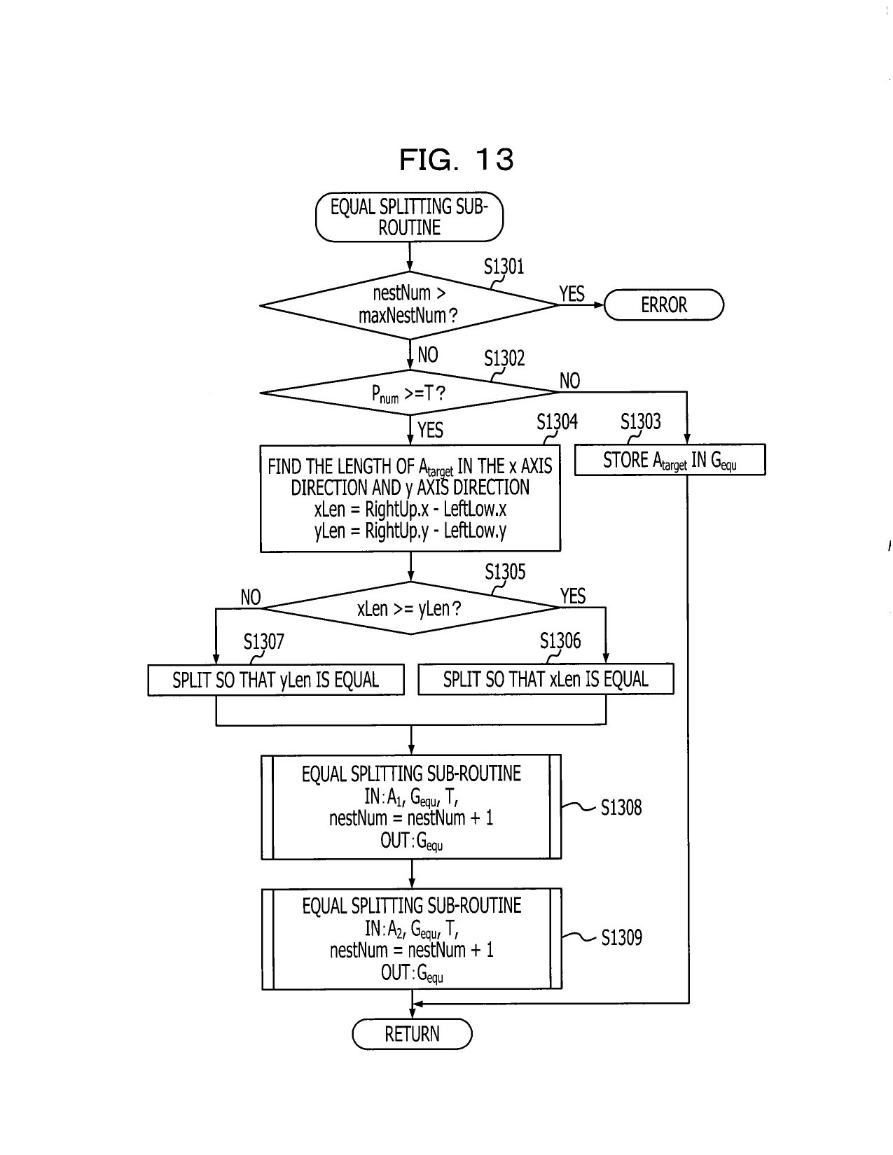

FIG. 13 is a flowchart describing a detailed processing example of equal splitting sub-routine (step S1206) described in FIG. 12. First, the splitting device 700 is determined whether or not nestNum>maxNestNum holds (step S1301). When nestNum>maxNestNum (Yes in step S1301), the region splitting satisfying the matching percentage r is not made and an error output is made.

On the other hand, when nestNum>maxNestNum does not hold (No in step S1301), the splitting device 700 determines whether or not Pₙᵤₘ≧T—(step S1302). Pₙᵤₘ is the number of the point data points in the region to be targeted for splitting A_{target}. When Pₙᵤₘ≧T does not hold (No in step S1302), the number of the point data points in the region to be targeted for splitting A_{target} Pₙᵤₘ is less than the equal splitting halt condition T. Therefore, the splitting device 700 is added the region to be targeted for splitting A_{target} to set G_{equ} without further equal splitting (step S1303).

On the other hand, when Pₙᵤₘ≧T (Yes in step S1302), the splitting device 700 finds length xLen in the X axis direction of the region to be targeted for splitting A_{target} and length yLen in the Y axis direction (step S1304). For example, xLen and yLen are calculated by the following Expressions (12) and (13).

xLen=RightUp.x−LeftLow.x (12)

yLen=RightUp.y−LeftLow.y (13)

RightUp.x is an X-coordinate value of the upper right vertex RightUp of the region to be targeted for splitting A_{target}, and LeftLow.x is an X-coordinate value of the lower-left vertex LeftLow of the region to be targeted for splitting A_{target}. Also, RightUp.y is an Y coordinate value of the upper right vertex RightUp of the region to be targeted for splitting A_{target}, and LeftLow.y is an Y coordinate value of the lower-left vertex LeftLow of the region to be targeted for splitting A_{target}.

The splitting device 700 then determines whether or not xLen≧yLen (step S1305). In the case of xLen>yLen, the region to be targeted for splitting A_{target} is a rectangle which is long length in X axis direction. On the other hand, in the case of non-xLen≧yLen, the region to be targeted for splitting A_{target} is a rectangle which is long length in the Y axis direction. In the case of xLen=yLen, the region to be targeted for splitting A_{target} is a square, but it is treated as a rectangle which is long in the X axis direction.

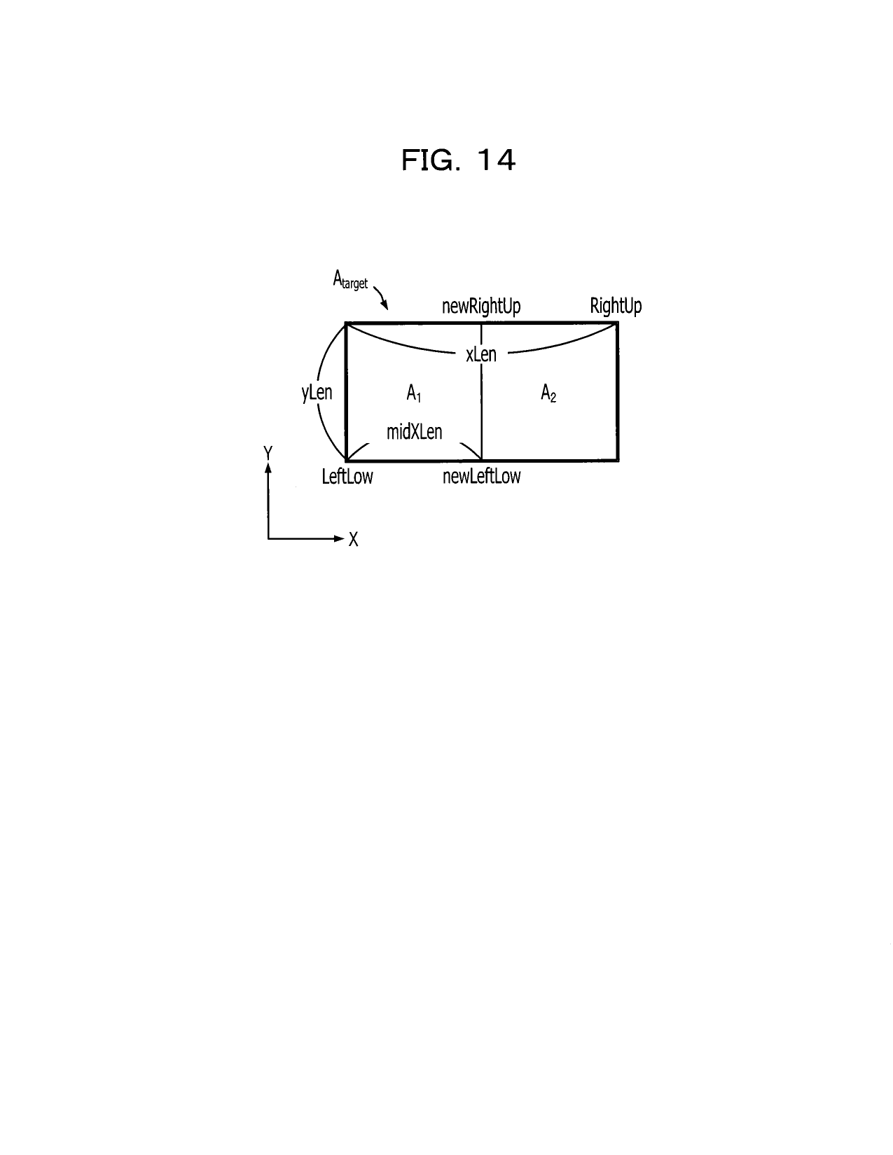

In the case of xLen≧yLen (Yes in step S1305), the splitting device 700 splits the region to be targeted for splitting A_{target} so that the xLen is split equally (step S1306), and the flow transitions to step S1308. Thereby, equally split splitting regions A1 and A2 are obtained from the region to be targeted for splitting A_{target}. The detailed splitting example will be described in FIG. 14.

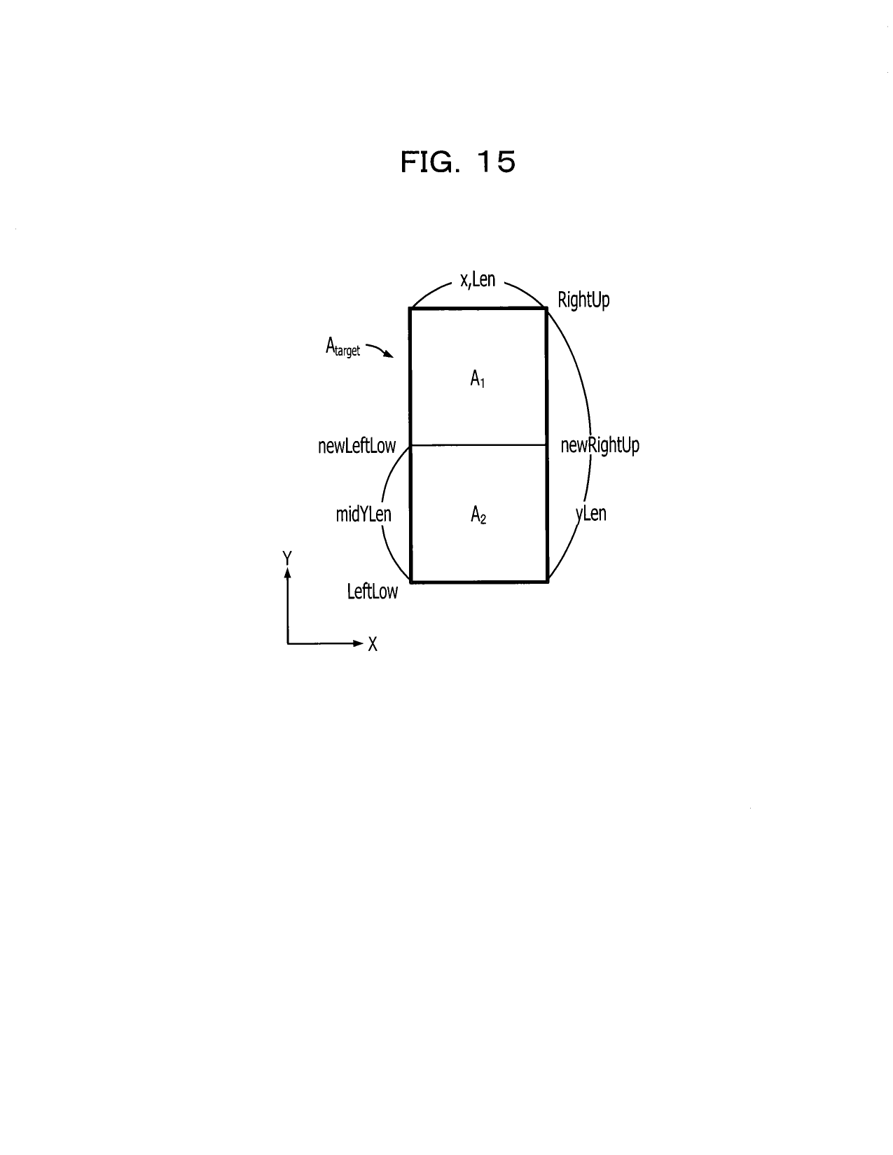

On the other hand, in the case of non-xLen≧yLen (No in step S1305), the splitting device 700 splits the region to be targeted for splitting A_{target} so that yLen is split equally (step S1307), and the flow transitions to step S1308. Thereby, equally split splitting regions A1 and A2 are obtained from the region to be targeted for splitting A_{target}. A detailed splitting example will be described in FIG. 15.

The splitting device 700 then performs equal splitting sub-routine of step S1206 recursively regarding splitting region A1 (step S1308). Input in the equal splitting sub-routine (step S1308) is a region A_{target}=A1, and set G_{equ} at the present, equal splitting halt condition T, and incremented equal splitting number of times nestNum=nestNum+1. Output in the equal splitting sub-routine (step S1308) is region set G_{equ} after equal splitting.

Also, when an equal splitting subroutine (step S1308) is ended (step S1309), the splitting device 700 performs equal splitting sub-routine of step S1206 recursively regarding the splitting region A2. Input in the equal splitting sub-routine (step S1309) is region A_{target}=A2, set G_{equ} at the present, equal splitting halt condition T, and incremented equal splitting number of times nestNum=nestNum+1. Output in the equal splitting sub-routine (step S1309) is region set G_{equ} after equal splitting.

In the equal splitting sub-routine (step S1308), when the region A_{target} is added to the set G_{equ} in step S1303, or the equal splitting sub-routine (step S1309) performed recursively is ended, the flow returns to RETURN and transitions to the equal splitting sub-routine (step S1309). Also, in the equal splitting sub-routine (step S1309), when the region A_{target} is added to the set Gequin in step S1303, or the equal splitting sub-routine (step S1309) performed recursively is ended, the flow returns to RETURN.

FIG. 14 is an explanatory diagram illustrating an equal splitting example in step S1306 of FIG. 13. In step S1306, the splitting device 700 splits the region to be targeted for splitting A_{target} so that xLen is split equally. Specifically, calculation of the following Expressions (14) to (18) is performed.

midXLen=xLen/2 (14)

newRightUp=(LeftLow.x+midXLen,RightUp.y) (15)

newLeftLow=(LeftLow.x+midXLen,LeftLow.y) (16)

The equally split region is a rectangle formed by the opposite vertices as with the following Expressions (17) and (18).

A1=[LeftLow,newRightUp] (17)

A2=[newLeftLow,RightUp] (18)

FIG. 15 is an explanatory diagram illustrating an equal splitting example in step S1307 of FIG. 13. In step S1307, the splitting device 700 splits the region to be targeted for splitting A_{target} so that yLen is split equally. Specifically, calculation of expression described below (19) to (23) is performed.

midYLen=yLen/2 (19)

newRightUp=(LeftLow.x,RightUp.y+midYLen) (20)

newLeftLow=(LeftLow.x,LeftLow.y+midYLen) (21)

The equally split region is a rectangle formed by the opposite vertices as with the following Expressions (22) and (23).

A1=[newLeftLow,RightUp] (22)

A2=[LeftLow,newRightUp] (23)

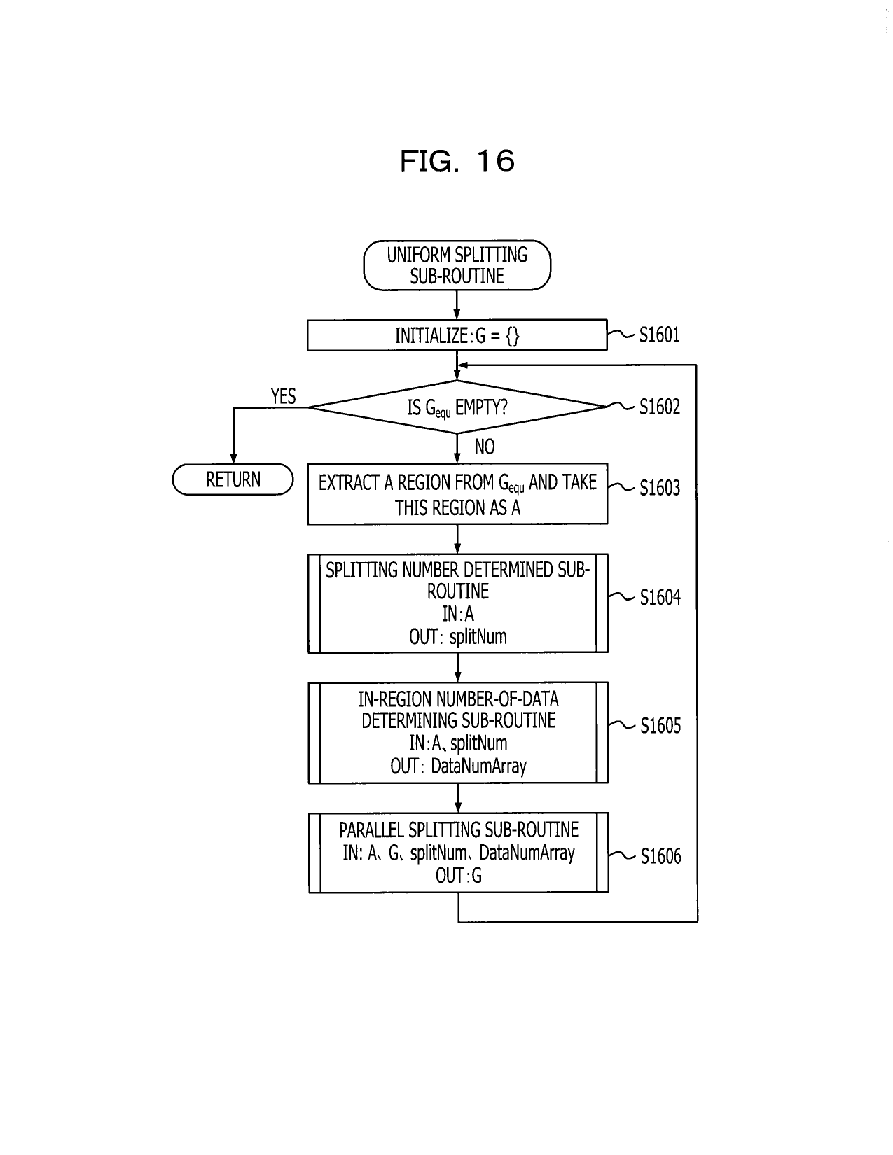

FIG. 16 is a flowchart describing a detailed processing example of uniform splitting sub-routine (step S1207) depicted in FIG. 12. First, the splitting device 700 sets region set G after uniform splitting for G={ } by initialization (step S1601). G={ } designates an empty set. The splitting device 700 then determines whether or not the set G_{equ} obtained by the equal splitting sub-routine (step S1206) is an empty set (step S1602). In the case that the set G_{equ} is not an empty set (No in step S1602), the splitting device 700 extracts one region from the set G_{equ} (step S1603). Let us call the extracted region “region A”

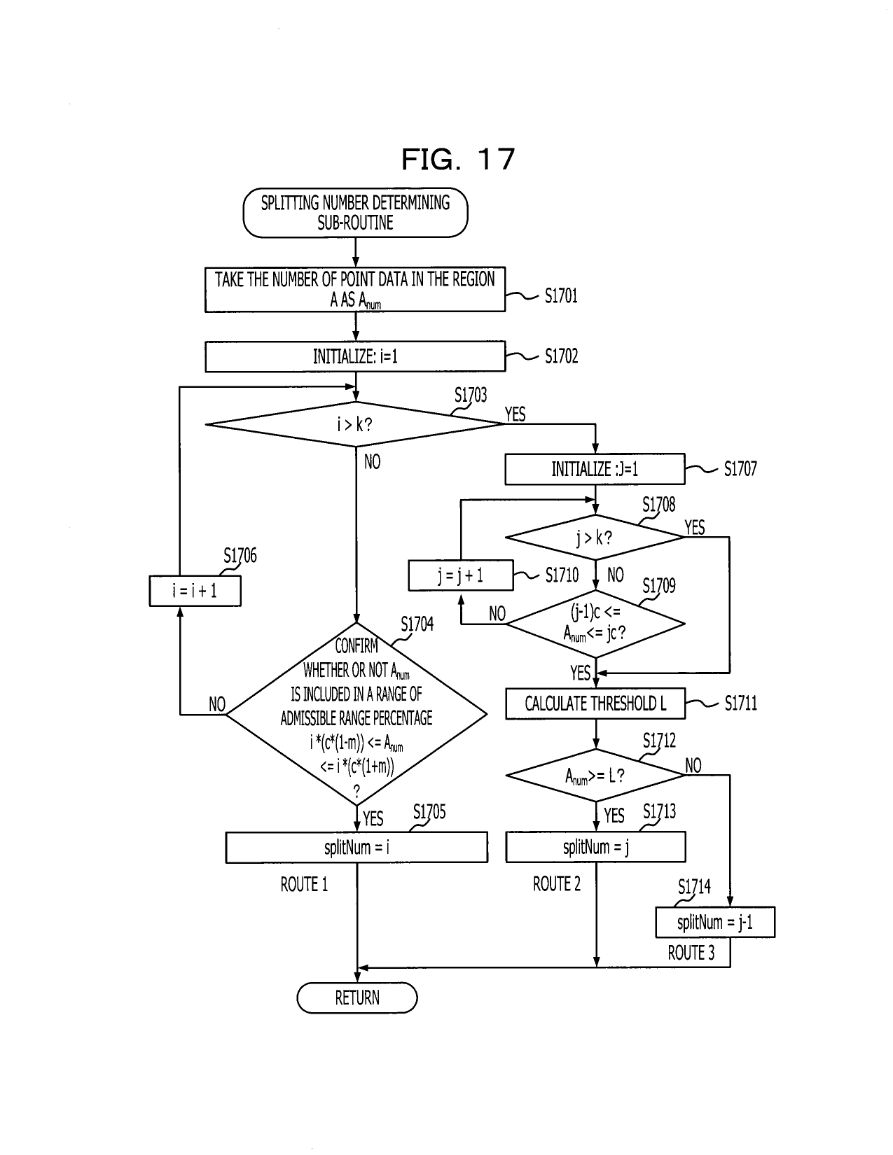

The splitting device 700 thereafter performs the splitting number determining sub-routine by the splitting number determining unit 741 regarding region A (step S1604). In the splitting number determining sub-routine (step S1604), splitting device 700 determines splitting number splitNum of region A. That is to say, the input of the splitting number determining sub-routine (step S1604) is region A, and the output is splitting number splitNum. Thus, the number of regions for splitting the number of the point data points in the region to uniformly split is obtained. The details of the splitting number determining sub-routine (step S1604) is described in FIG. 17.

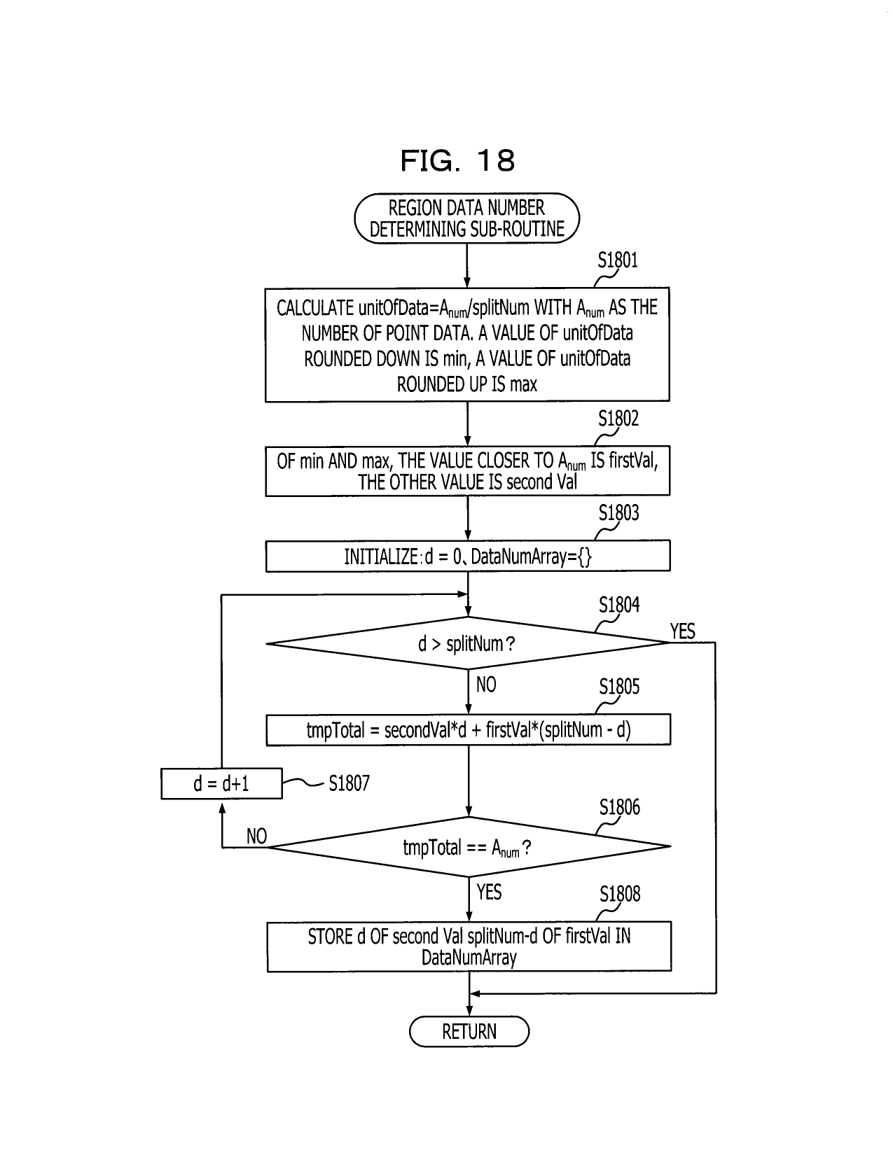

The splitting device 700 then performs in-region number-of-data decision sub-routine (step S1605). In the in-region number-of-data decision sub-routine (step S1605), the splitting device 700 determines the number of the point data points included in each region split from region A in splitting number splitNum. Input of the in-region number-of-data determining sub-routine (step S1605) is region A, splitting number splitNum of region A, and output is point data number column DataNumArray. The point data number line DataNumArray is a sequence of numbers for the splitting number splitNum. Each value of the sequence is the number of the point data points included in each region uniformly split by the region A. For example, in the case of point data number line DataNumArray={9, 9, 10}, the number of each point data points of three regions split uniformly from the region A, this is nine, nine, and ten. The details of the in-region number-of-data determining sub-routine (step S1605) will be described in FIG. 18.

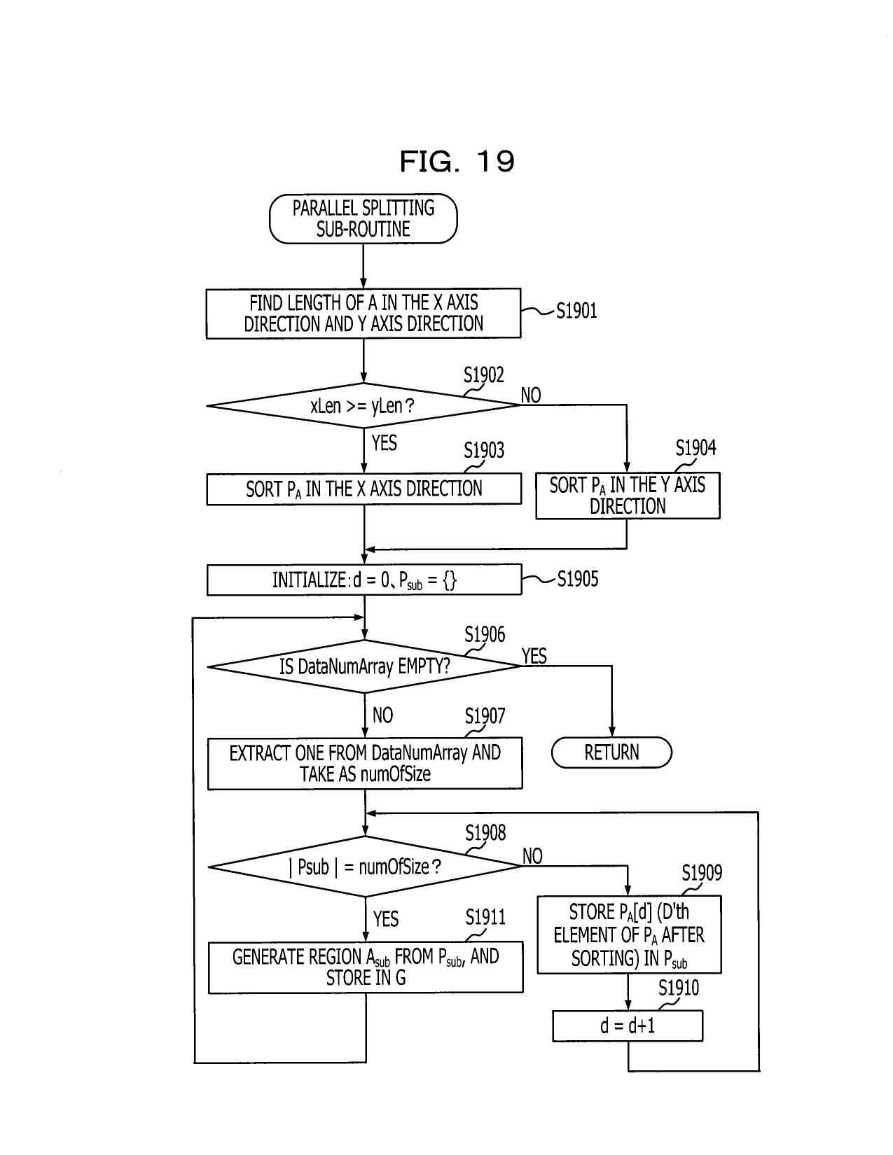

The splitting device 700 then performs parallel splitting sub-routine (step S1606). In the parallelism splitting sub-routine (step S1606), the splitting device 700 splits the region A parallel, for example, parallel to the X axis direction. Uniform splitting is performed so as to include point data for the number in point data number line DataNumArray, to each split region. For example, in the case of point data number line DataNumArray={9, 9, 10}, three regions uniformly split from region A, nine, nine, ten point data points will be included. After parallel splitting sub-routine (step S1606), the flow returns to step S1602. In step S1602, set G_{equ} is an empty set (Yes in step S1602), parallel splitting sub-routine (step S1606) is ended. The details of the parallel splitting sub-routine (step S1606) will be described in FIG. 19.

FIG. 17 is a flowchart illustrating detailed processing of splitting number determining sub-routine (step S1604) depicted in FIG. 16. First, the splitting device 700 takes the number of the point data points in the region A as Aₙᵤₘ (step S1701). The splitting device 700 then initializes variable i and sets i=1 (step S1702). The splitting device 700 determines whether or not i>k (step S1703). k is the greatest uniform splitting number.

If not i>k (No in step S1703), the splitting device 700 determines whether or not the number of the point data points in the region A Aₙᵤₘ is included in a section defined by the admissible range percentage m (step S1704). Specifically, the splitting device 700 determines whether or not the number of the point data points in the region A Aₙᵤₘ is included in the following Expression (24) (see. FIG. 11).

i×{c×(1−m)}≦Aₙᵤₘ≦i×{c×(1+m)} (24)

When the number of the point data points in the region A Aₙᵤₘ is included in a section defined by admissible range percentage m (Yes in step S1704), the splitting device 700 may uniformly divide the region A by the number i. Therefore, the splitting device 700 determines splitting number splitNum of the region A to splitNum=i (step S1705). Note that, an execution path to step S1705 will be referred to as “Route 1”. Thereby, splitting number determining sub-routine (step S1604) is ended.

On the other hand, when the number of the point data points in the region A Aₙᵤₘ is not included in the section defined by admissible range percentage m (No in step S1704), i is incremented (step S1706) and returned to step S1703. In this way, the splitting device 700 may search a section where i is included, until i is beyond the greatest number of uniform divisions k.

When i>k (Yes in step S1703), the splitting number is a value out of the section defined by admissible range percentage m. First, to search the value, the splitting device 700 initializes variable j and makes j=1 (step S1707). The splitting device 700 then determines whether or not j>k (step S1708). When not being j>k (No in step S1708), whether or not the number of the point data points in the region A Aₙᵤₘ satisfies the following Expression (25) is determined (step S1709).

(j−1)×c≦=Aₙᵤₘ≦=j×c (25)

When Expression (25) is not satisfied (No in step S1709), j is incremented (step S1710), returned to step S1708, satisfy Expression (25) (Yes in step S1709) and the flow transitions to step S1711. Also, in step S1708, when being j>k (Yes in step S1708), the flow proceeds to step S1711. That is to say, the splitting device 700 searches the number of x points of point data illustrated in FIG. 11 in processing of step S1707 to S1710.

In step S1711, the splitting device 700 calculates threshold L illustrated in the above Expression (10) (step S1711). The splitting device 700 then determines whether or not Aₙᵤₘ≧L is, regarding the number Aₙᵤₘ of the point data points in the region A (step S1712). When Aₙᵤₘ≧L (step S1712: Yes), the splitting device 700 determines the splitting number splitNum of the region A in splitNum=j (step S1713). Thereby, splitting number determining sub-routine (step S1604) is ended.

Note that an execution path to step S1713 will be referred to as “Route 2”. On the other hand, when Aₙᵤₘ≧L does not hold (No in step S1712), the splitting device 700 determines the splitting number splitNum of the region A in splitNum=j−1 (step S1714). Thus, the splitting number determining sub-routine (step S1604) is ended. Note that, an execution path to step S1714 will be referred to as “Route 3”.

That is to say, regarding processing from steps S1711 to S1714, as depicted in FIG. 11, when the number of the point data points in the region A Aₙᵤₘ exceeds L, j splitting may approximate the number of point data points after uniform splitting to target number c. Therefore, splitting number splitNum is determined in j. Also, when the number of the point data points in the region A Aₙᵤₘ does not exceeds L, (j−1) splitting may approximate the number of point data points after uniform splitting to target number c. Therefore, splitting number splitNum is determined in (j−1). Thus, the splitting device 700 may determine the splitting number where the number of point data points in the region is as close as possible to the target number c, even if the section defined by admissible range percentage m is out of the section.

FIG. 18 is a flowchart describing a detailed processing procedure of the in-region number-of-data determining (step S1605) depicted in FIG. 16. First, the splitting device 700 finds number of the point data points per 1 region unitOfData by dividing the number of the point data points in the region A Aₙᵤₘ by the splitting number splitNum of region A. The splitting device 700 then takes the value which has the decimal places of unitOfData rounded down as the minimum value min and value which has the decimal places of unitOfData rounded up as the maximum value max (step S1801).

Next, the splitting device 700 sets, of the minimum value min and maximum value max, the closer value to the number of the point data points in the region A Aₙᵤₘ to firstVal, and the other value to secondVal (step S1802). For example, the number of the point data points in the region R3 of FIGS. 1B and 1C is 28 and the splitting number splitNum is 3, yielding unitOfData=28/3 which is approximately 9.3.

Therefore, the minimum value which has rounded down the decimal places of unitOfData=28/3 which is approximately 9.3 is min=9, and the maximum value is max=10. Of these, max=10 is a close value to the number of the point data points in the region A Aₙᵤₘ, and firstVal=10 and secondVal=9 hold.

The splitting device 700 takes variable d=0 and point data number line DataNumArray={ } (step S1803). The splitting device 700 then determines whether or not d>splitNum is (step S1804). When d>splitNum does not hold (No in step S1804), the splitting device 700 calculates the number of the point data points in the region A tmpTotal using firstVal and secondVal by the following Expression (26) (step S1805).

tmpTotal=secondVal×d+firstVal×(splitNum−d) (26)

The first term of right-hand side of Expression (26) denotes that, of the region groups equally split from the region A, secondVal point data is included in the d regions. Also, the second term of right-hand side of Expression (26) denotes that, of the region groups equally split from the region A, (splitNum−d) point data is included in the d regions. Therefore, when being tmpTotal=Aₙᵤₘ, a number column of point data points stored in point data number column DataNumArray is established.

Specifically, the splitting device 700 determines whether or not tmpTotal=Aₙᵤₘ (step S1806). When not tmpTotal=Aₙᵤₘ (No in step S1806), d is incremented (step S1807) and the flow returns to step S1804. On the other hand, when being tmpTotal=Aₙᵤₘ (Yes in step S1806), the splitting device 700 stores d secondVal and (splitNum-d) firstVal in the point data number line DataNumArray (step S1808). Thereby, the in-region number-of-data determining sub-routine (step S1605) is ended. Note that, in step S1804, when d>splitNum (Yes in step S1804), in-region number-of-data determining sub-routine (step S1605) is ended.

For example, when being the above described region R3 in FIG. 1, firstVal=10 and secondVal=9 hold, and at the time of d=0, tmpTotal=0+10×(3−0)=30 holds and it is a different value as the number of the point data points in the region A Aₙᵤₘ (=28). Therefore, d is incremented.

Then, at the time of d=1, tmpTotal=9+10×(3−1)=29 holds, which is a different value as the number of the point data points in the region A Aₙᵤₘ (=28). Therefore, d is incremented. Then, at the time of d=2, tmpTotal=9×2+10×(3−2)=28 holds, which corresponds with the number of the point data points in the region A Aₙᵤₘ (=28). Therefore, point data number line DataNumArray is DataNumArray={9, 9, 10}. That is to say, the region uniformly split from the region R3 is one region including 10 points of point data and two regions including 9 points of point data.

FIG. 19 is a flowchart describing detailed processing procedures of the parallel splitting sub-routine (step S1606) depicted in FIG. 16. First, the splitting device 700 calculates length xLen in the X axis direction and length yLen in the Y axis direction of the region A using the Expressions (12) and (13) (step S1901). The splitting device 700 then determines whether or not xLen≧yLen is (step S1902). When xLen≧yLen (Yes in step S1902), point data group PA is sorted to the region A in the X axis direction (step S1903), and the flow transitions to step S1905. On the other hand, when not xLen≧yLen (No in step S1902), point data group PA is sorted to the region A in the Y axis direction (step S1904) and the flow transitions to step S1905.

That is to say, when being xLen>yLen, the region A is a long-length rectangle and accordingly the region A is uniformly split parallel to the Y-axis.

In this example, the case of xLen=yLen is equally handled. In the case of xLen<yLen, the region A is a long-length rectangle in the Y axis direction and accordingly the region A is uniformly split parallel to the X axis.

The splitting device 700 then sets variable d=0 and sets the set P_{sub}={ } (step S1905). Point data is stored in the set P_{sub}. The splitting device 700 then determines whether or not point data number line DataNumArray is an empty set (step S1906). If an empty set (Yes in step S1906), the parallel splitting sub-routine ends (step S1606). On the other hand, if not an empty set (No in step S1906), the splitting device 700 extracts one number of the point data points from point data number line DataNumArray (step S1907). The number of the extracted point data is taken as numOfSize. The splitting device 700 then determines whether or not |P_{sub}|=numOfSize (step S1908). |P_{sub}| is the number of the stored point data points in the set P_{sub}.

When |P_{sub}|=numOfSize does not hold (No in step S1908), the splitting device 700 stores the d'th point data PA [d] of the point data group PA after sorting by step S1903 or step S1904 in the set P_{sub} (step S1909), increments d (step S1910), and the flow returns to step S1908. The point data of the sort order is accumulated in the set P_{sub} by repeating steps S1908 through S1910.

When |P_{sub}|=numOfSize holds (Yes in step S1908), the splitting device 700 generates the region A_{sub} by the set P_{sub}, stores in set G (step S1911), and the flow returns to step S1906. Specifically, the splitting device 700 generates the region A_{sub} so as to be, of the point data group in the set P_{sub}, the border between point data of which sort order is the lowest and point data of which sort order is the next to this point data. After step S1911, the flow returns to step S1906, and steps S1907 through S1911 are executed until point data number line DataNumArray is empty. Therefore, in set G, the region A_{sub} in accordance with the point data number line DataNumArray is generated. For example, in the case of the above-described region R3 in FIGS. 1B and 1C, DataNumArray={9, 9, 10} holds, so two regions including nine points of point data and one region including ten points of point data are stored in the set G.

Region Splitting Example

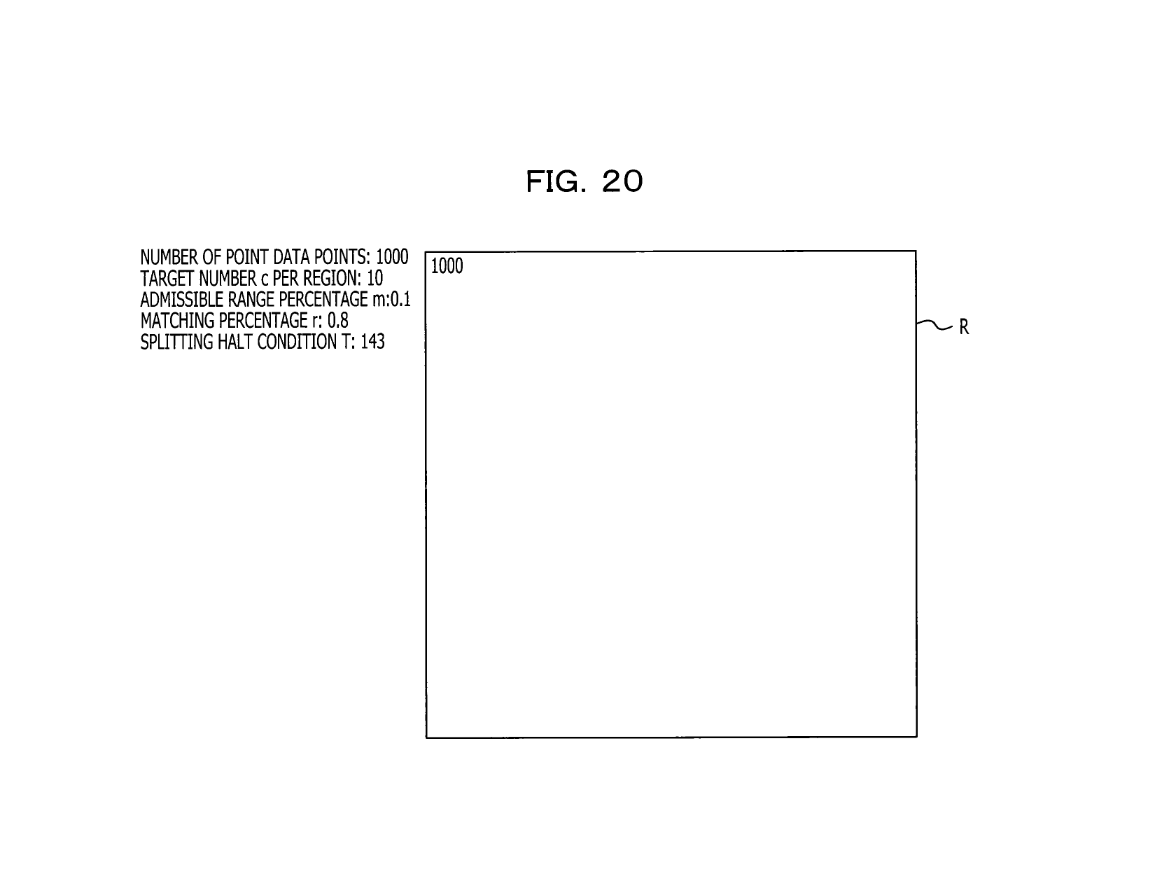

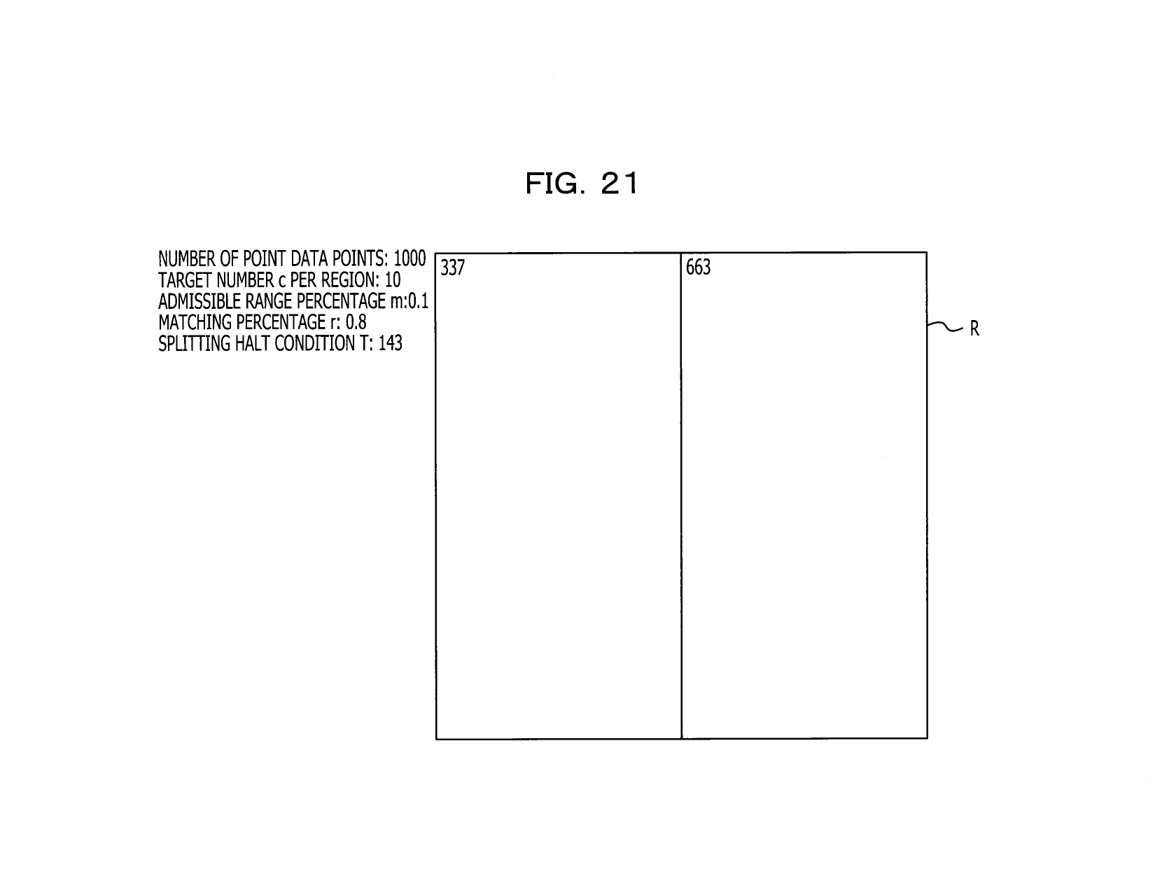

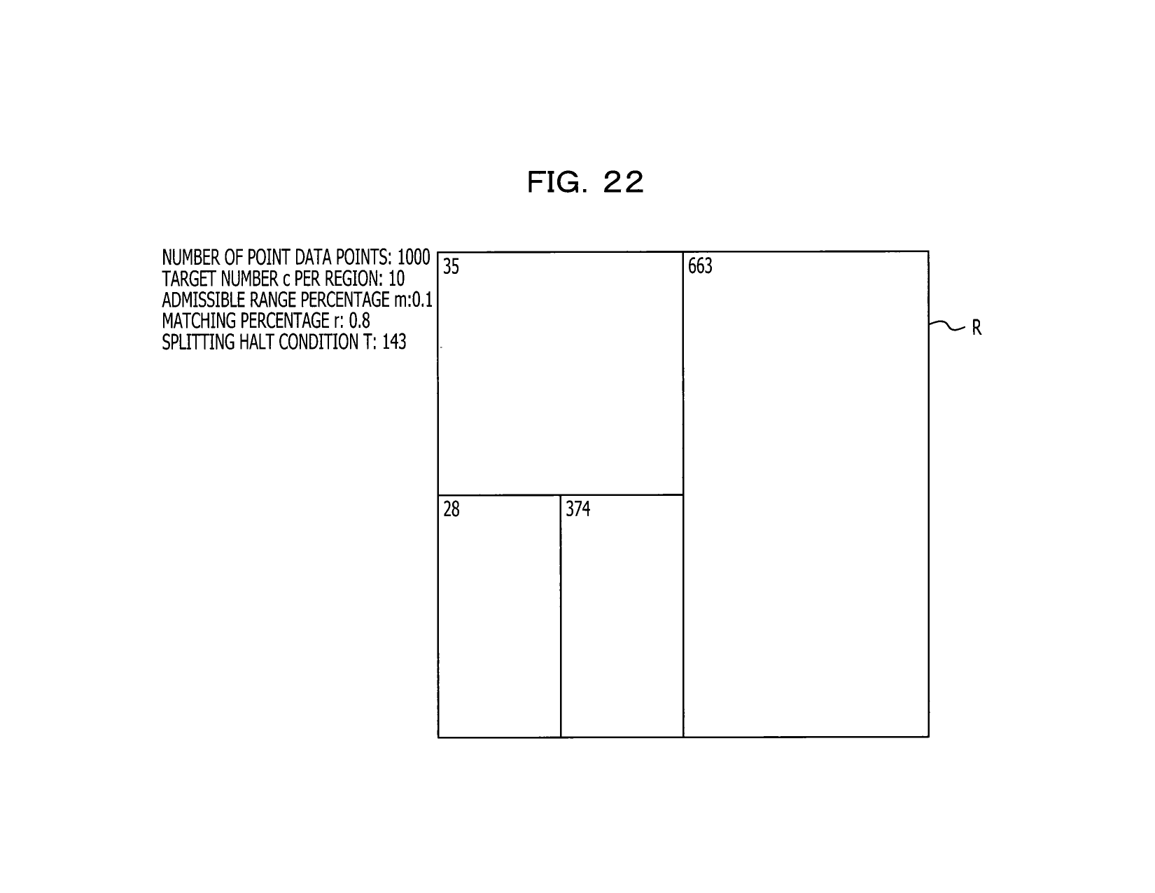

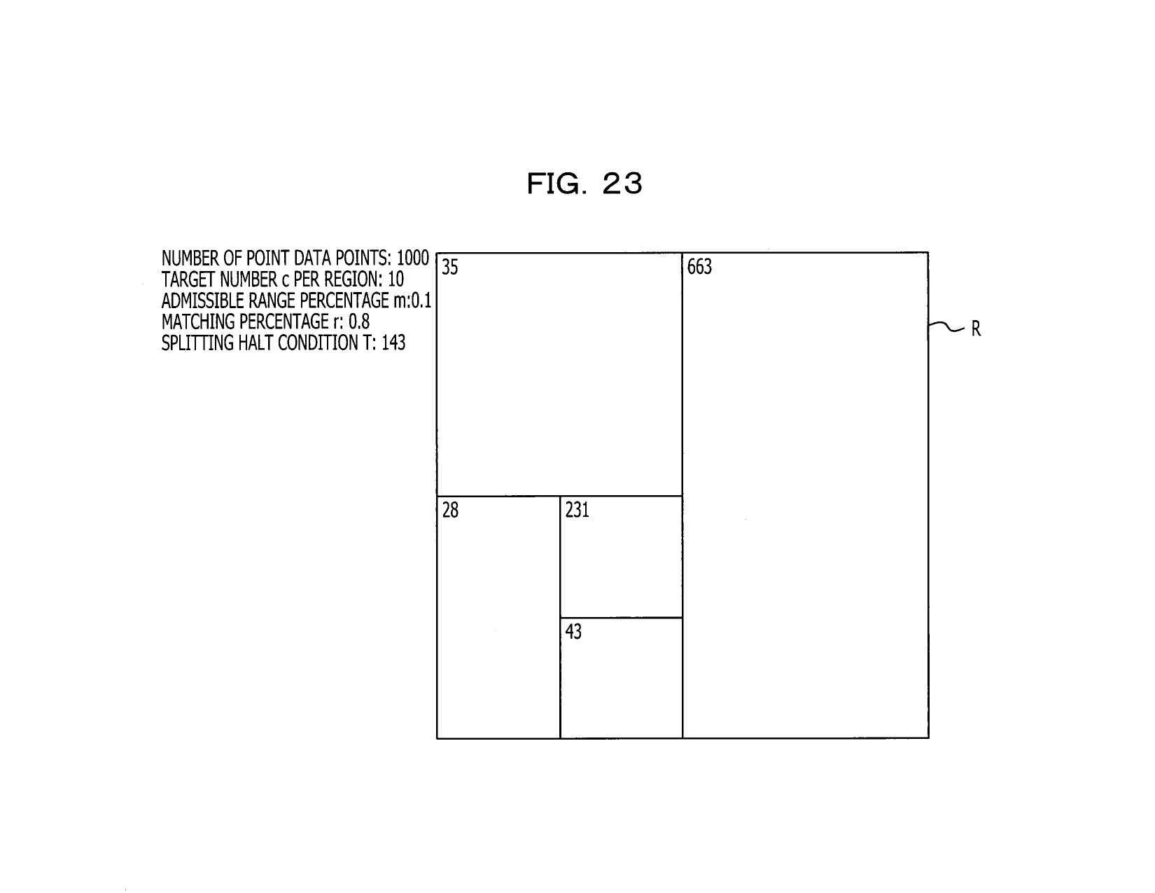

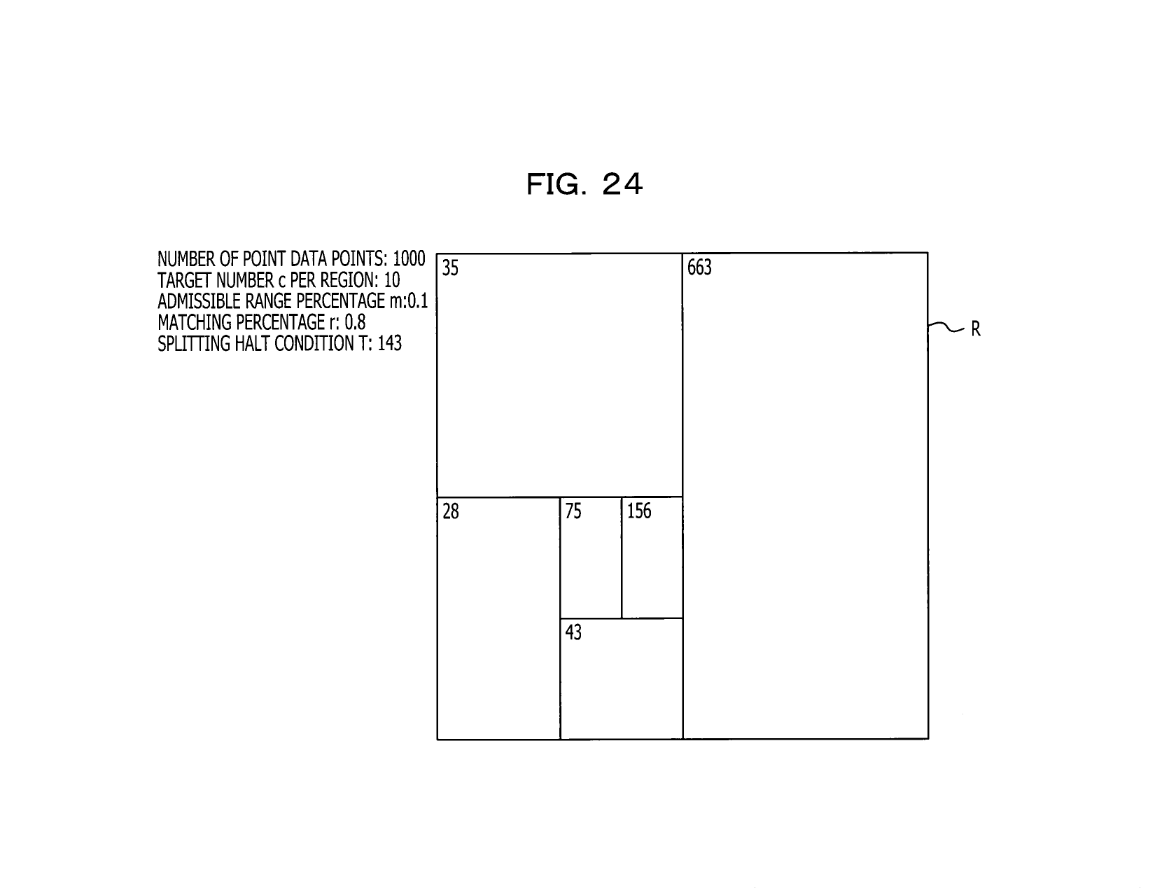

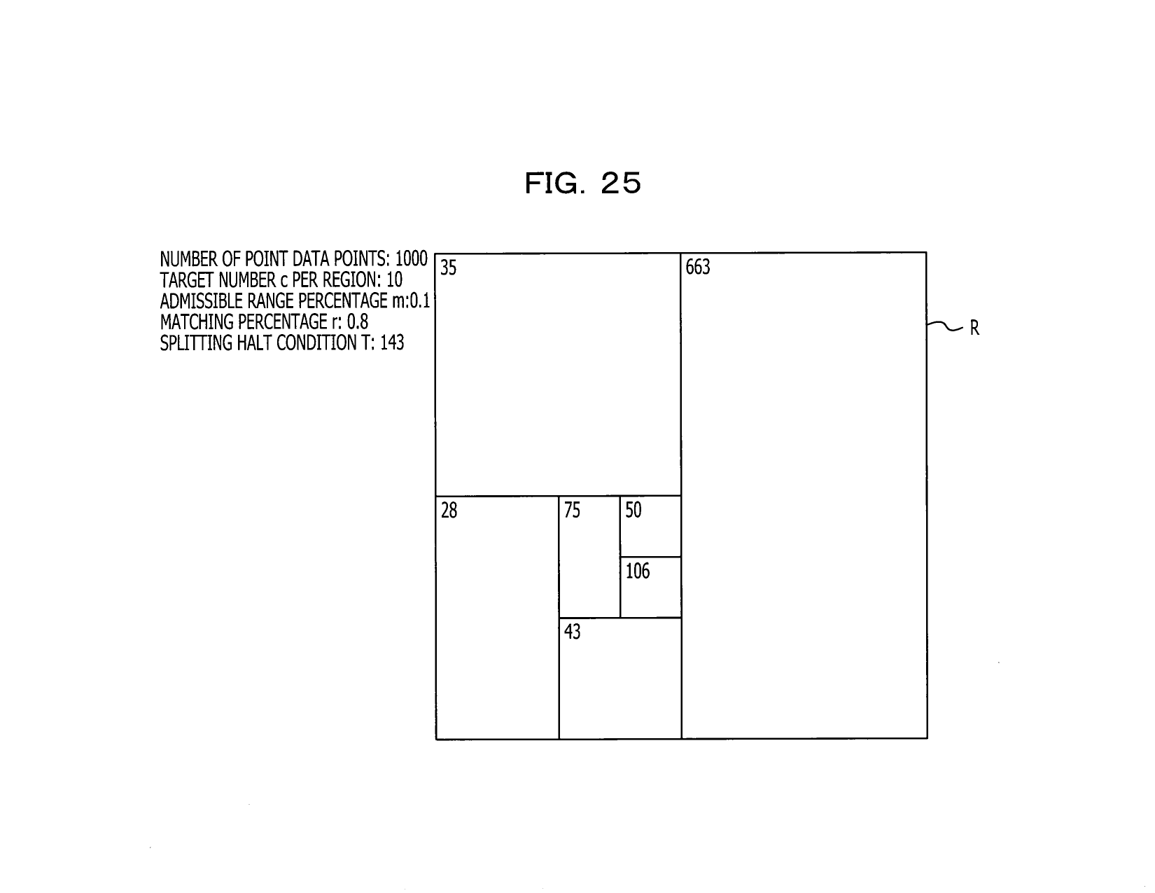

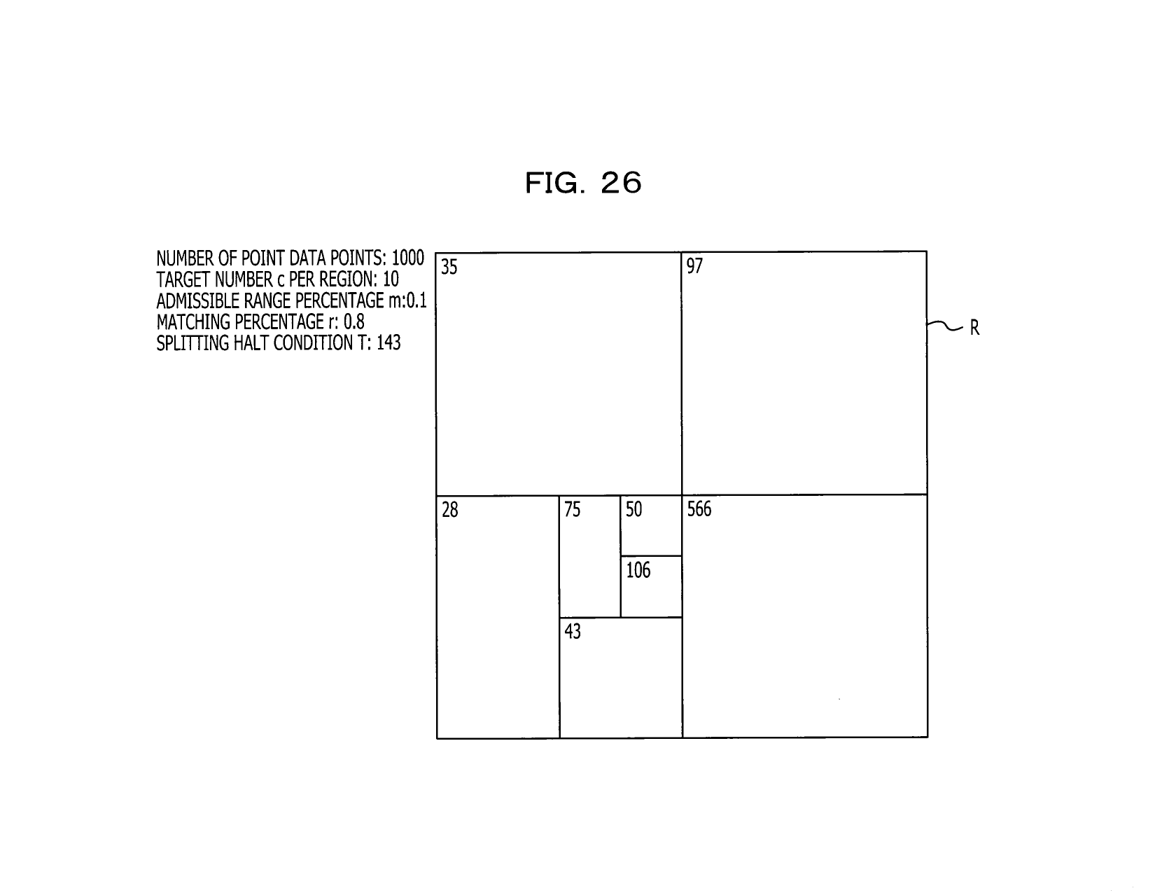

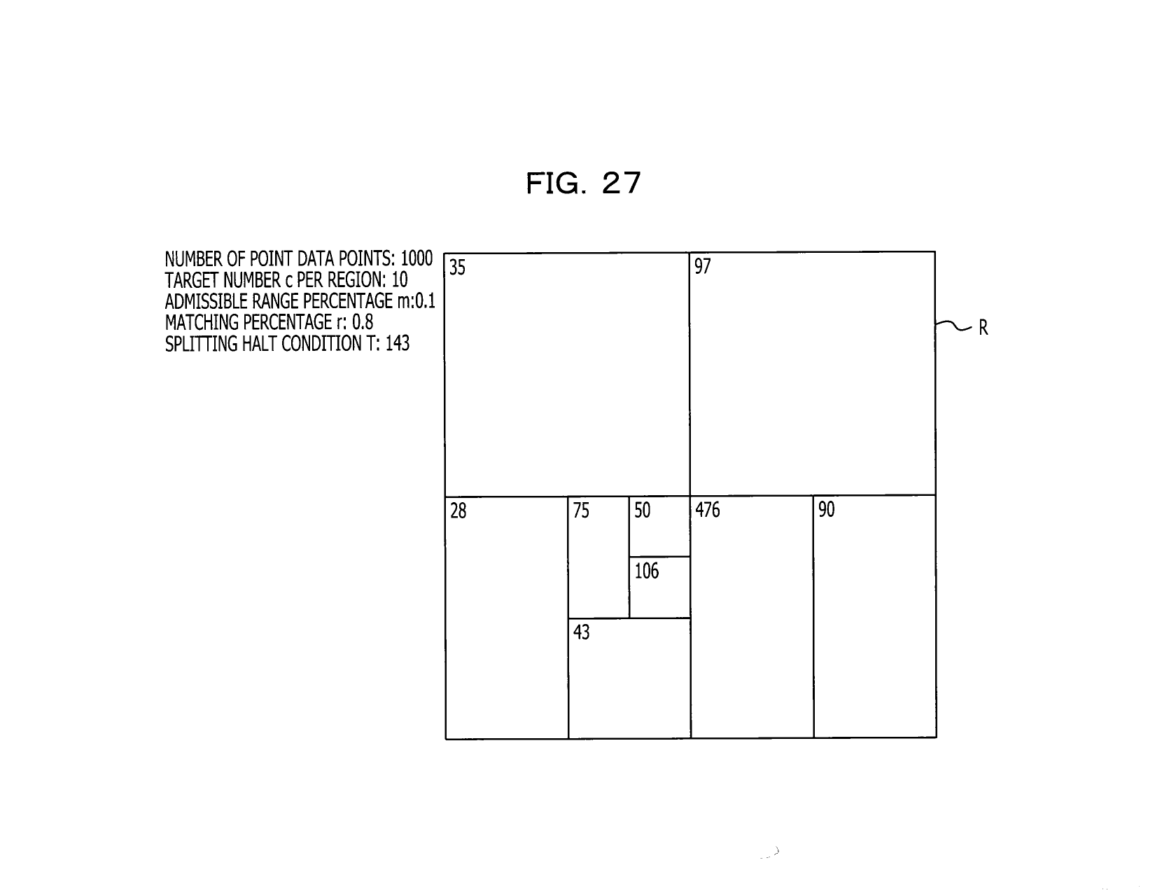

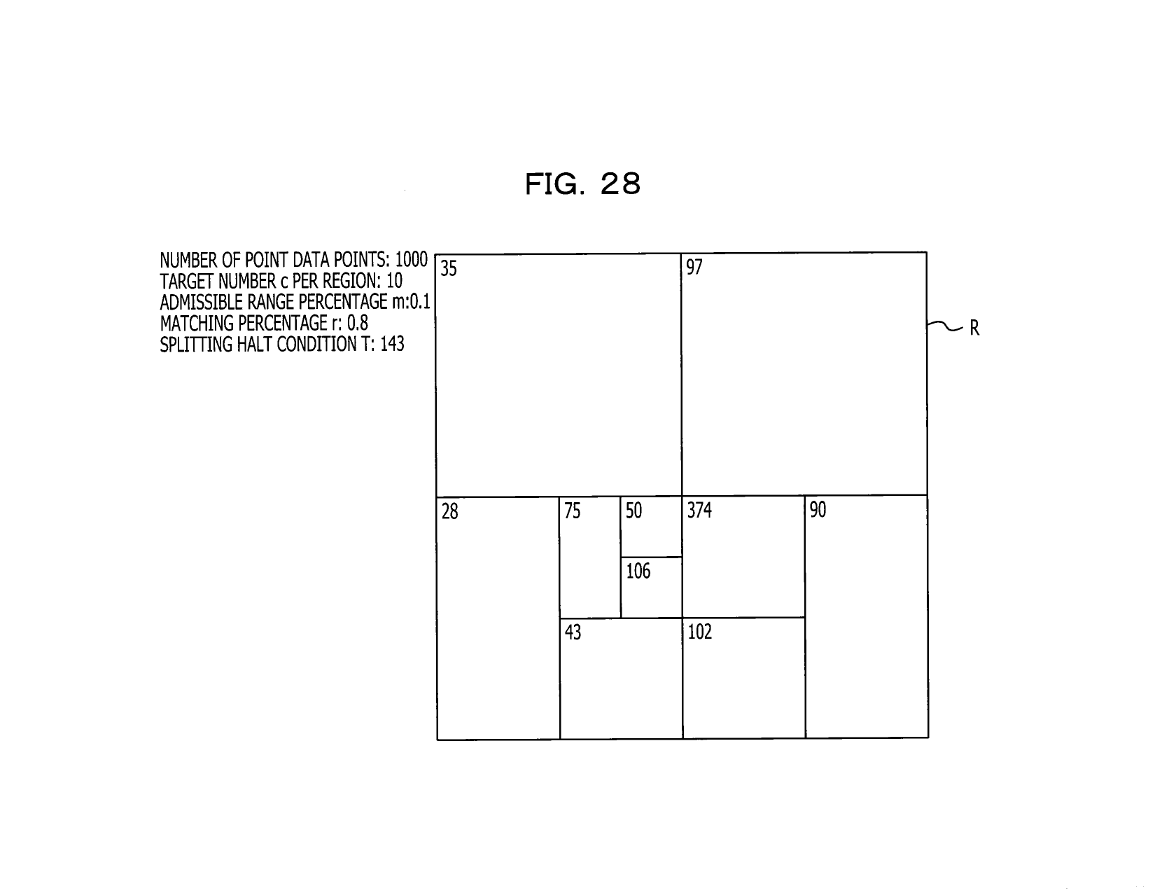

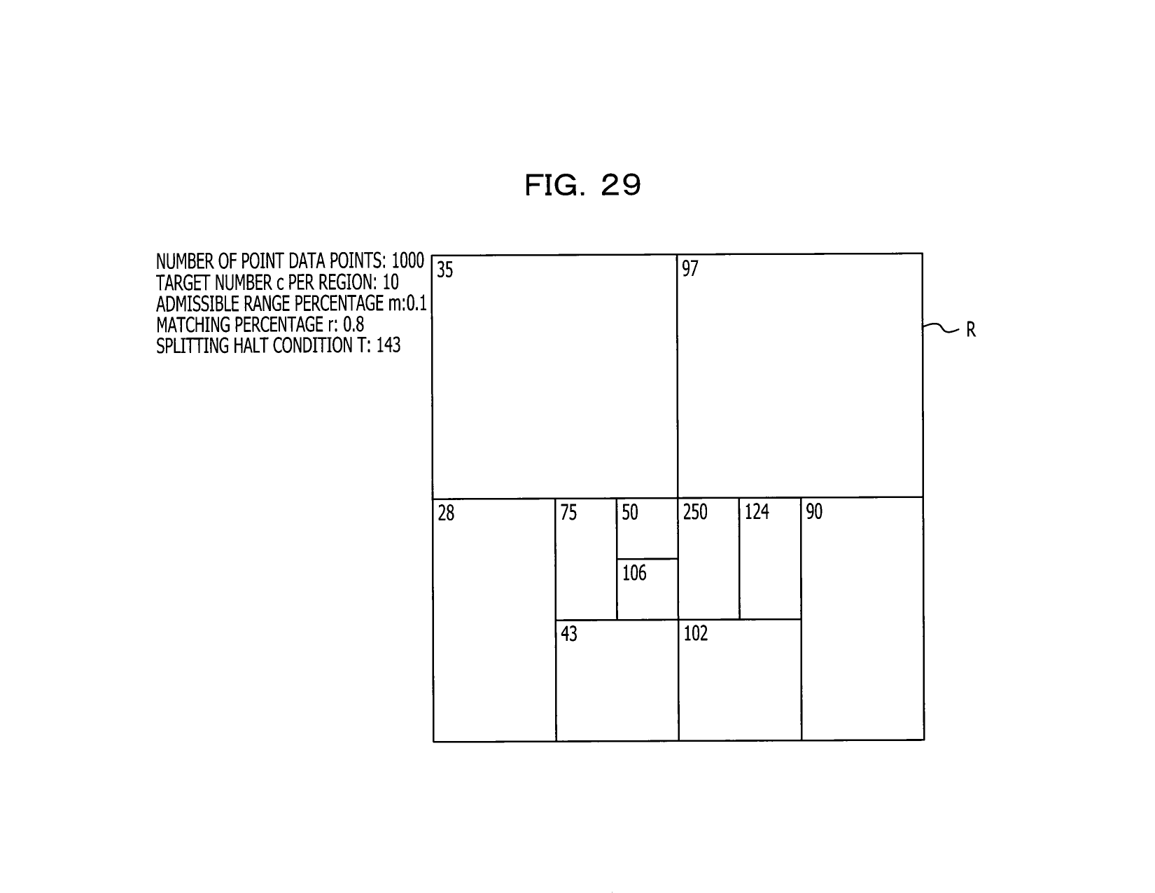

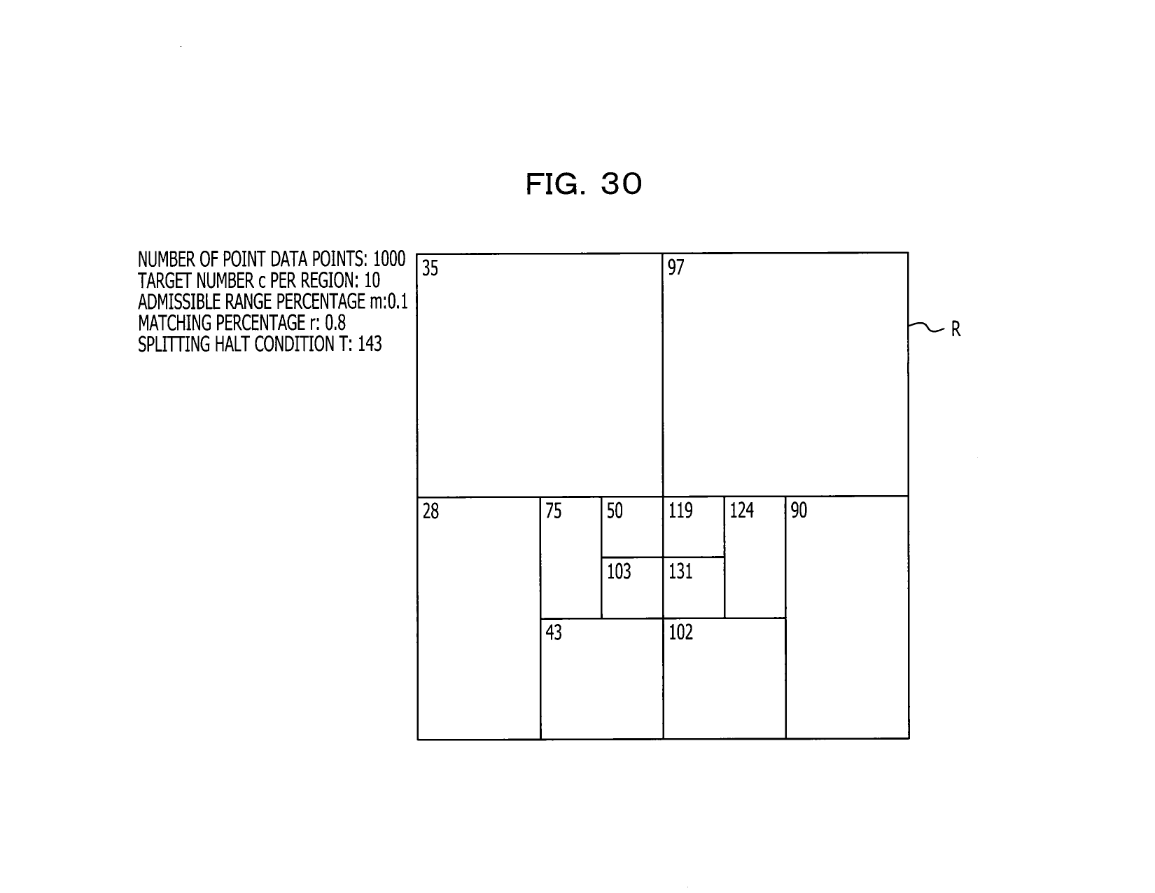

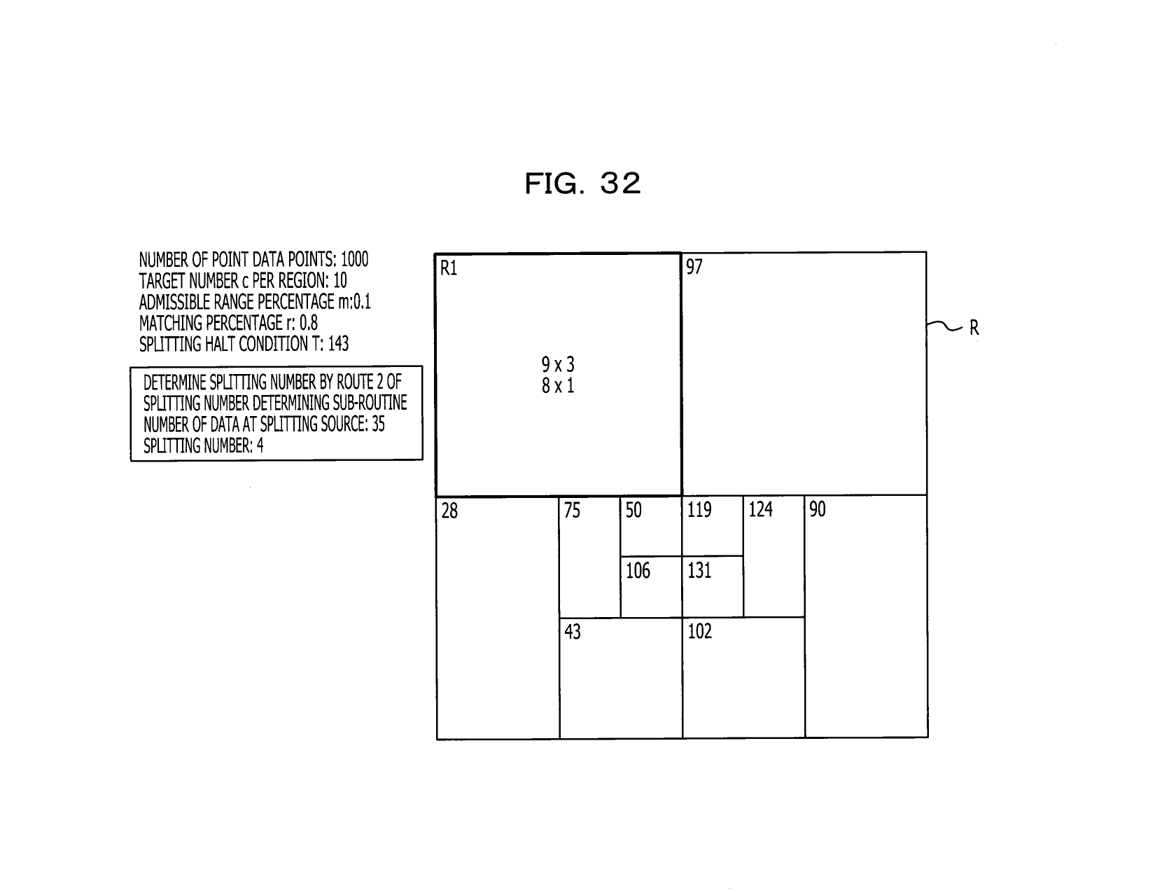

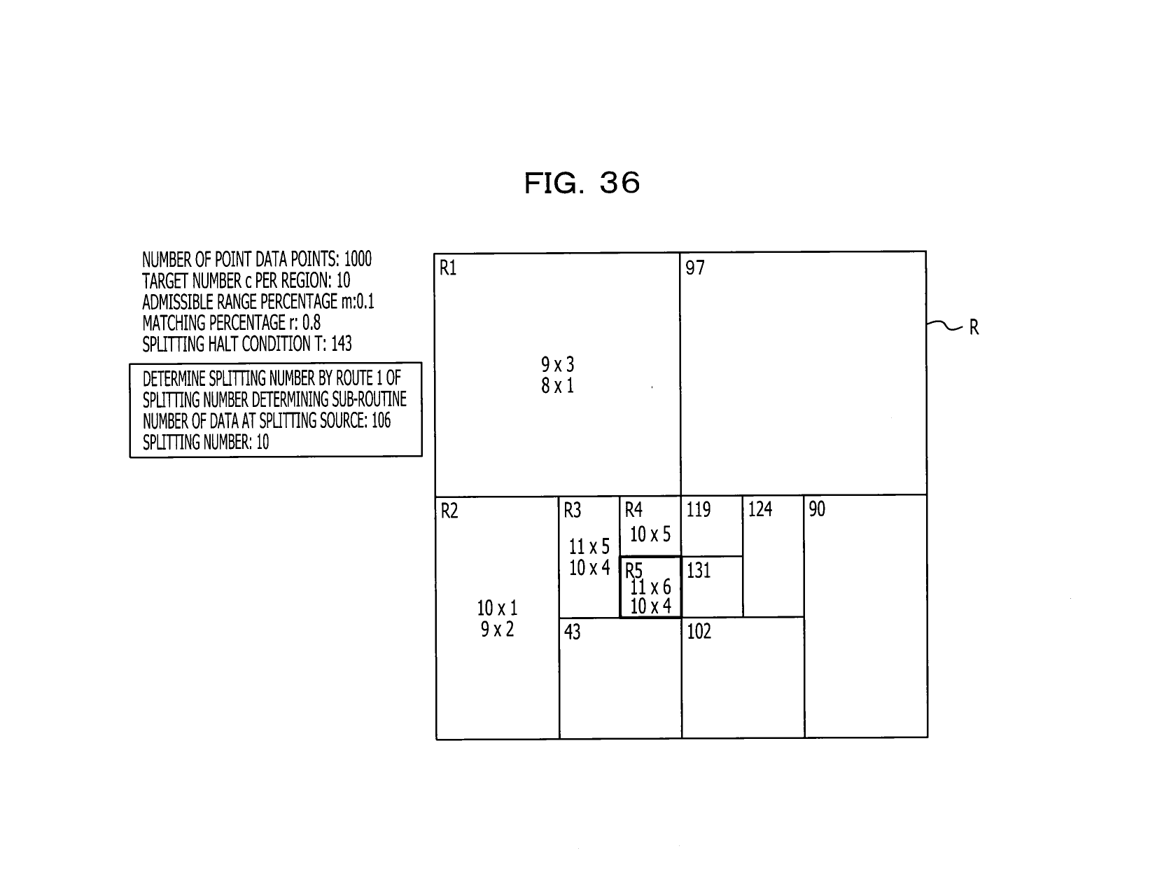

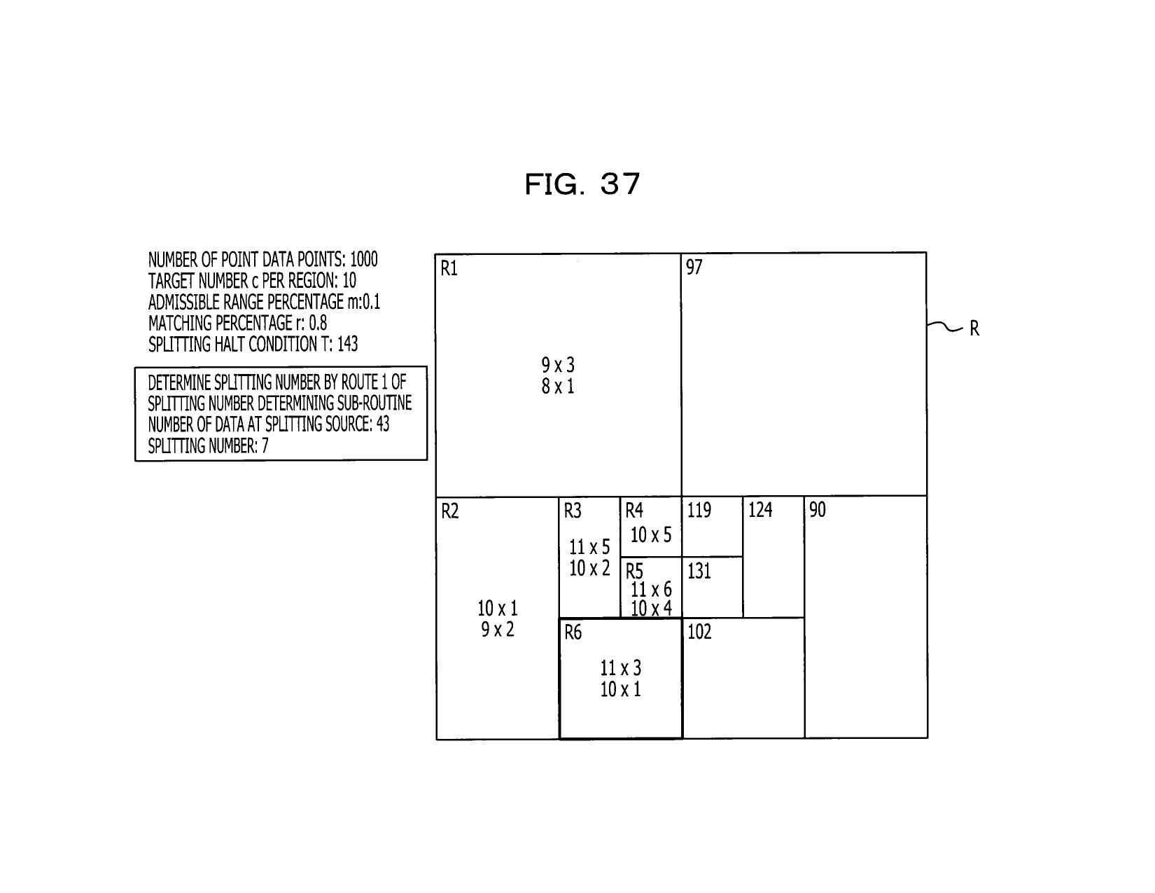

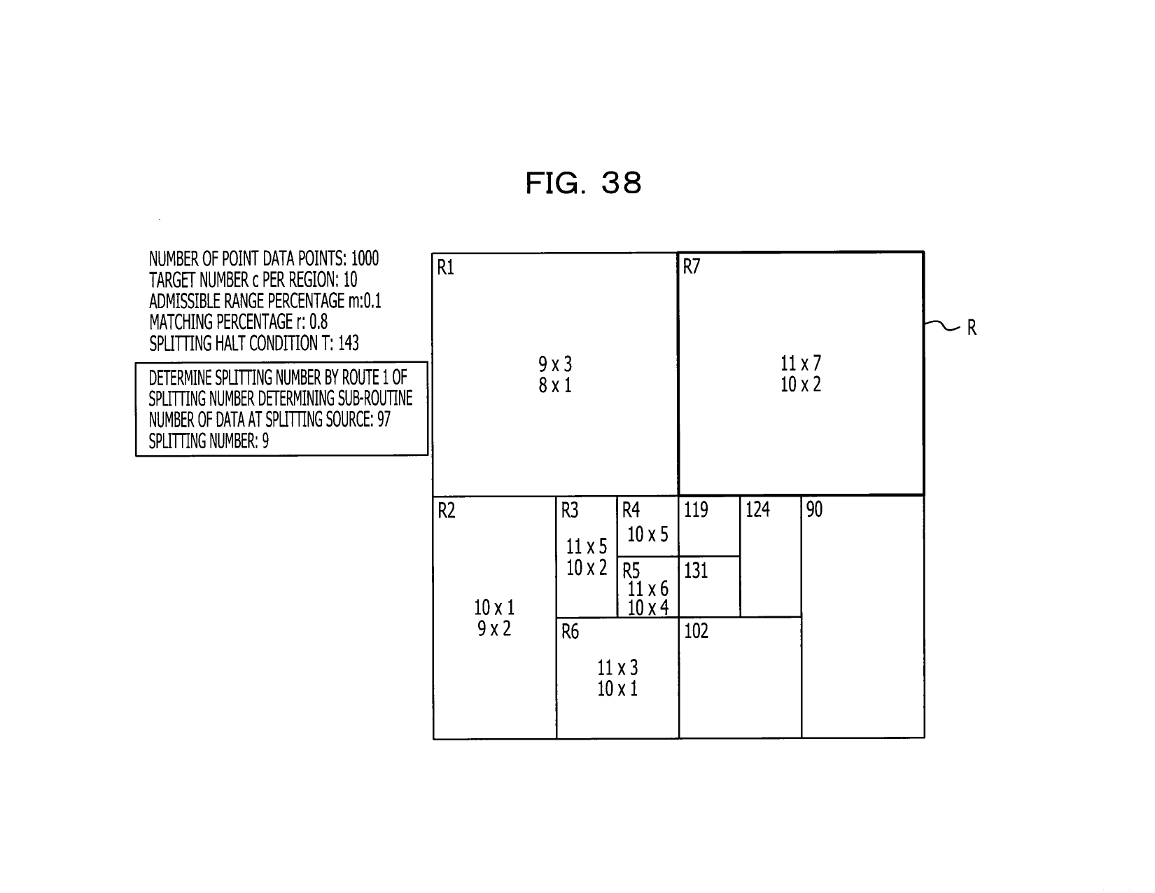

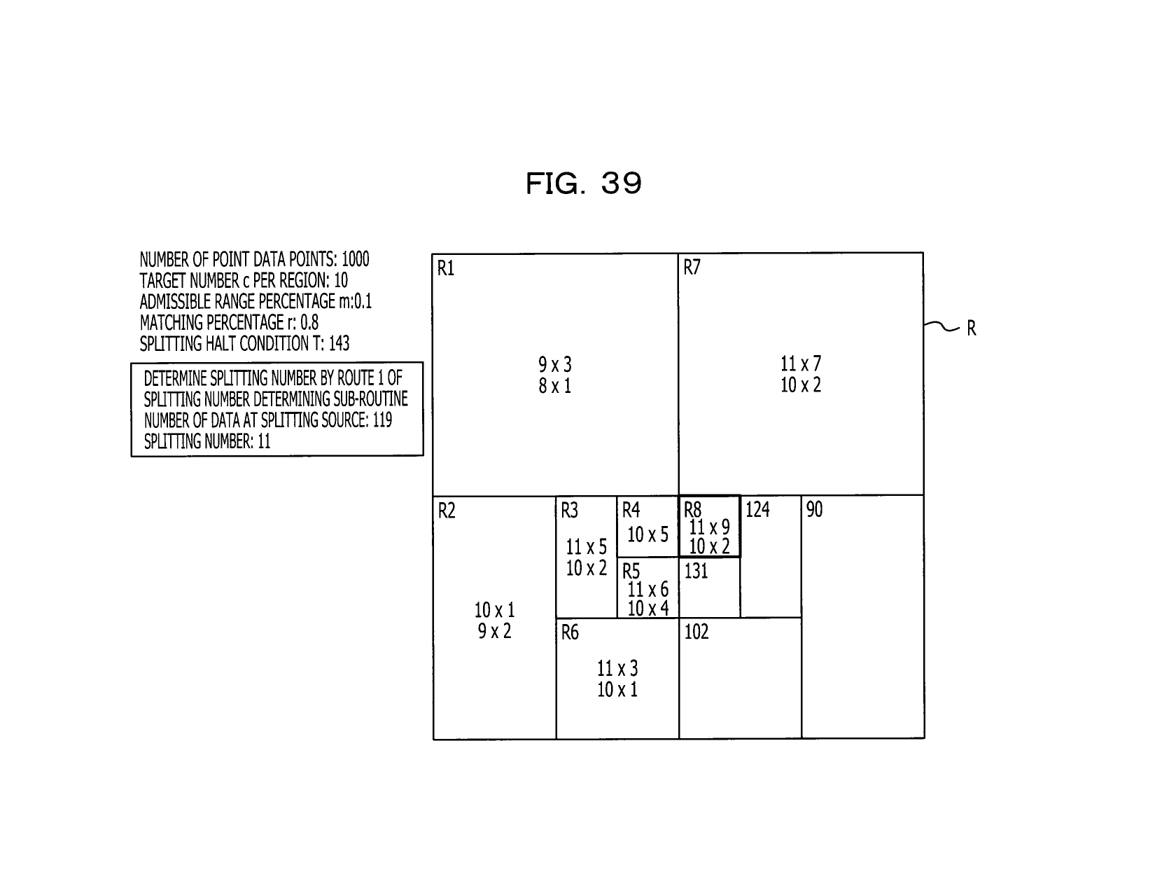

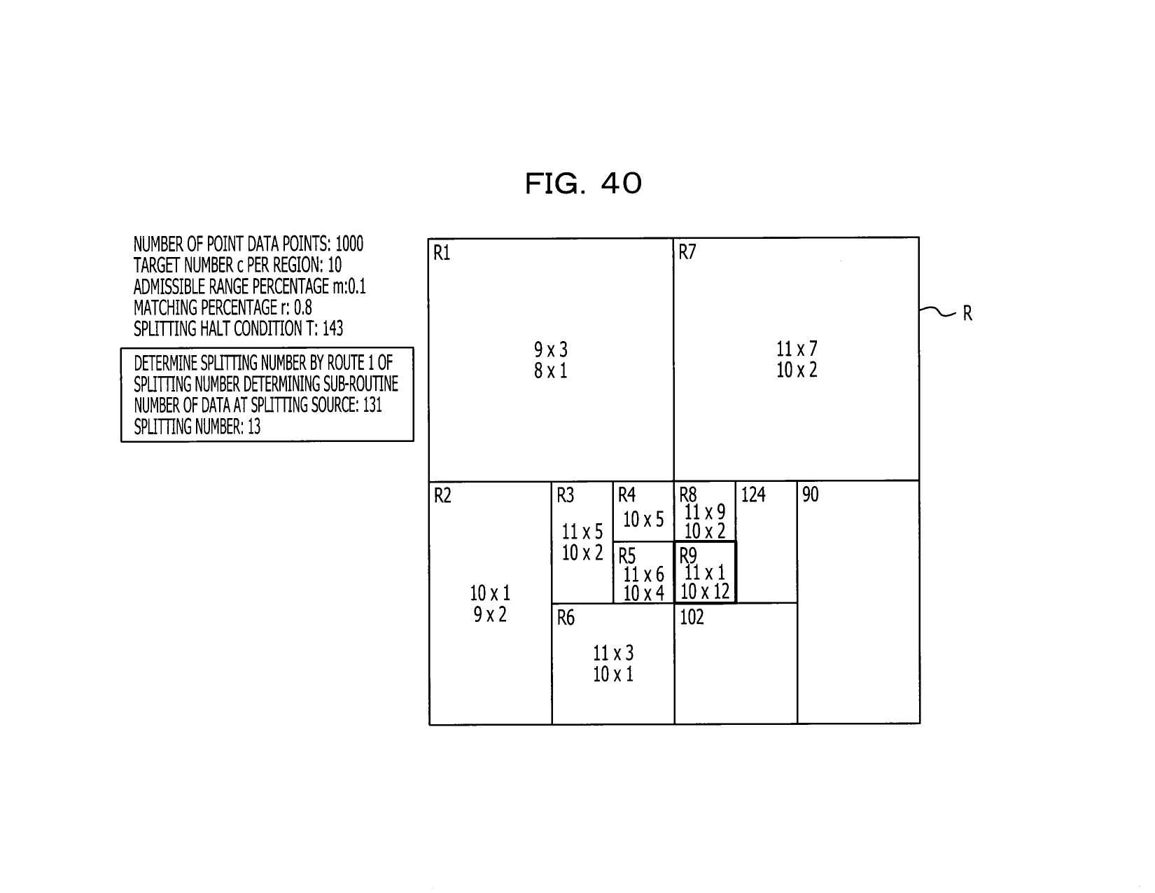

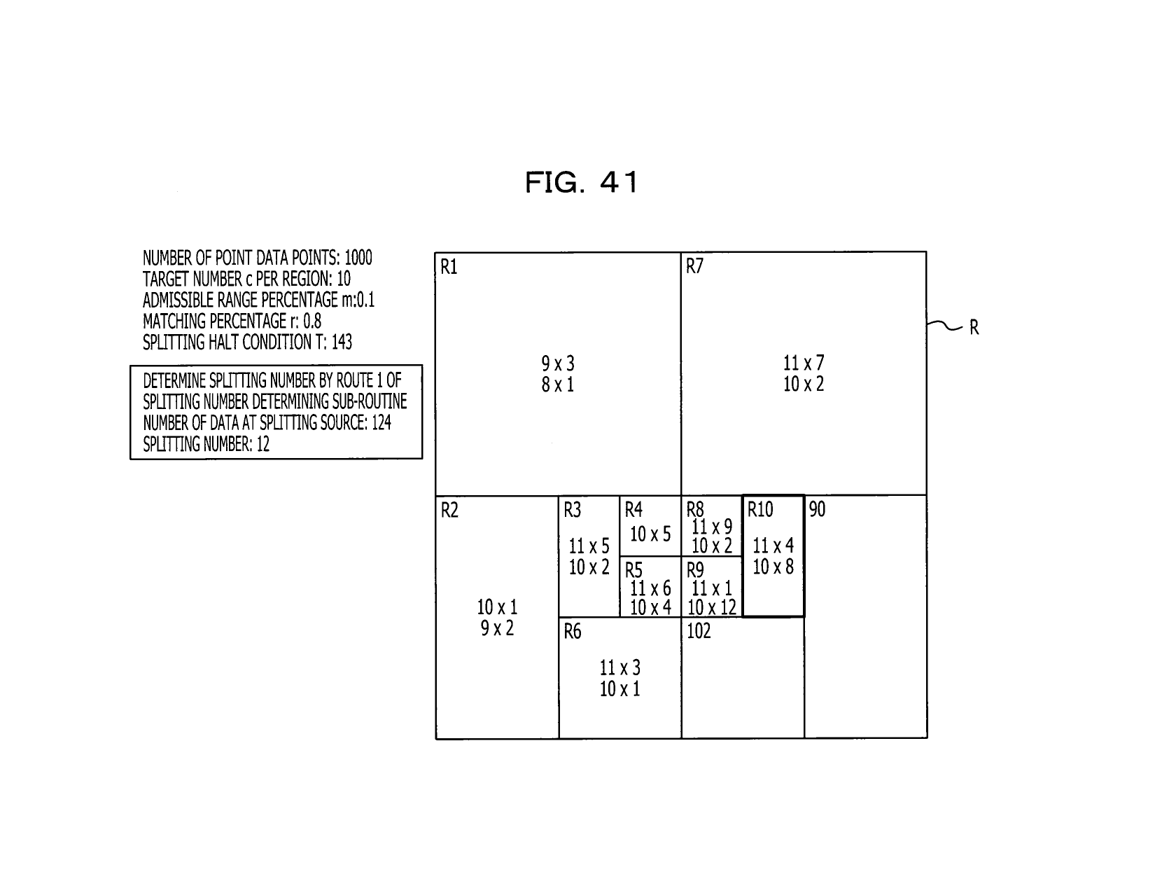

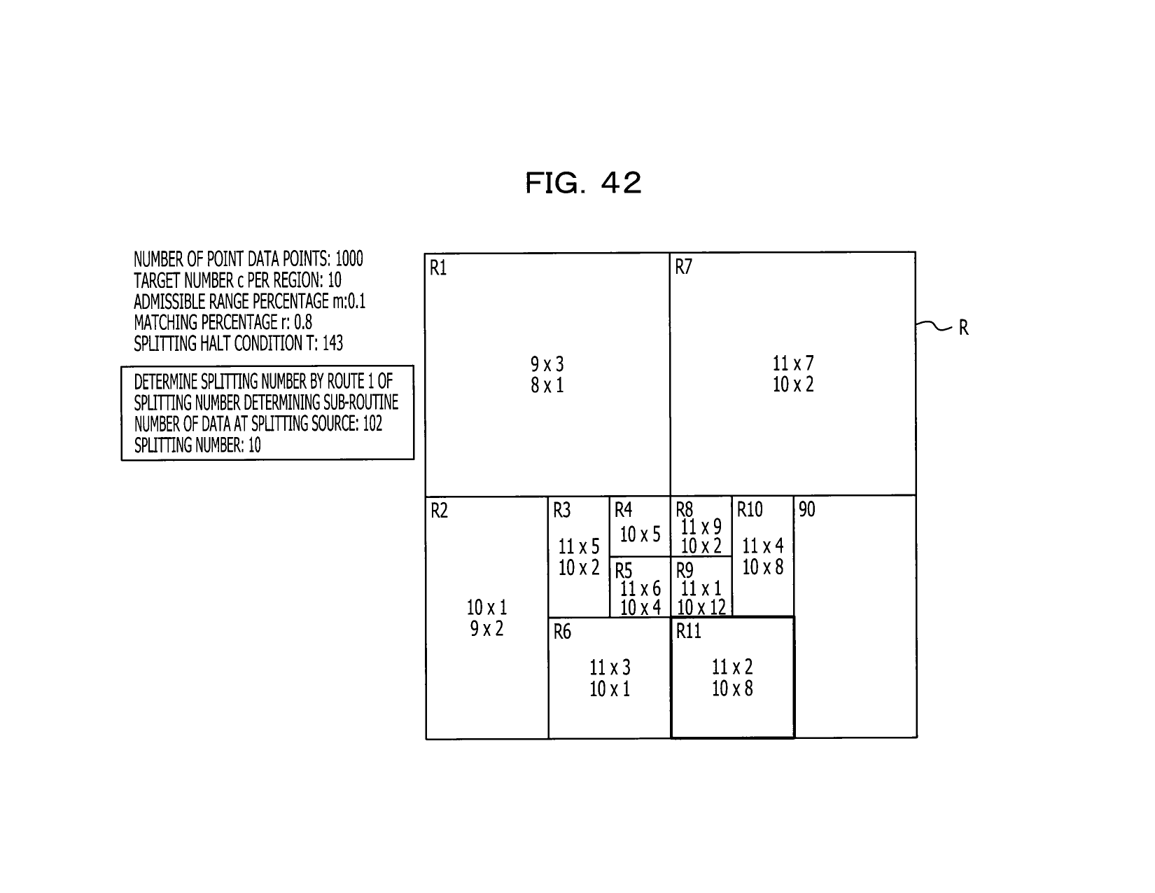

Next, specific examples of the region splitting will be described using FIGS. 20 through 43. FIGS. 20 to 43 are explanatory diagrams illustrating specific examples of the region splitting. Note that, in FIGS. 20 through 43, the point data in a region depicted with a rectangle is indicated as the number of the point data points in the region. A numerical value to the upper left in the region is the number of the point data points in the region. First, FIG. 20 indicates the initial state. There are 1,000 points of points data in the region R. Also, let us assume that target number c=10, admissible range percentage m=0.1, matching percentage r=0.8, and splitting halt condition T=143. With up to FIG. 21 through FIG. 30, equal splitting is illustrated. That is to say, equal splitting is performed regarding the regions until they are below the splitting halt condition T. In the state of FIG. 30, the number of all region point data points is less than the equal splitting halt condition T, and accordingly the equal splitting is ended. The flow then transitions to uniform splitting depicted in FIGS. 32 through 43, but description will be made first to supplement regarding notations in FIGS. 32 through 43.

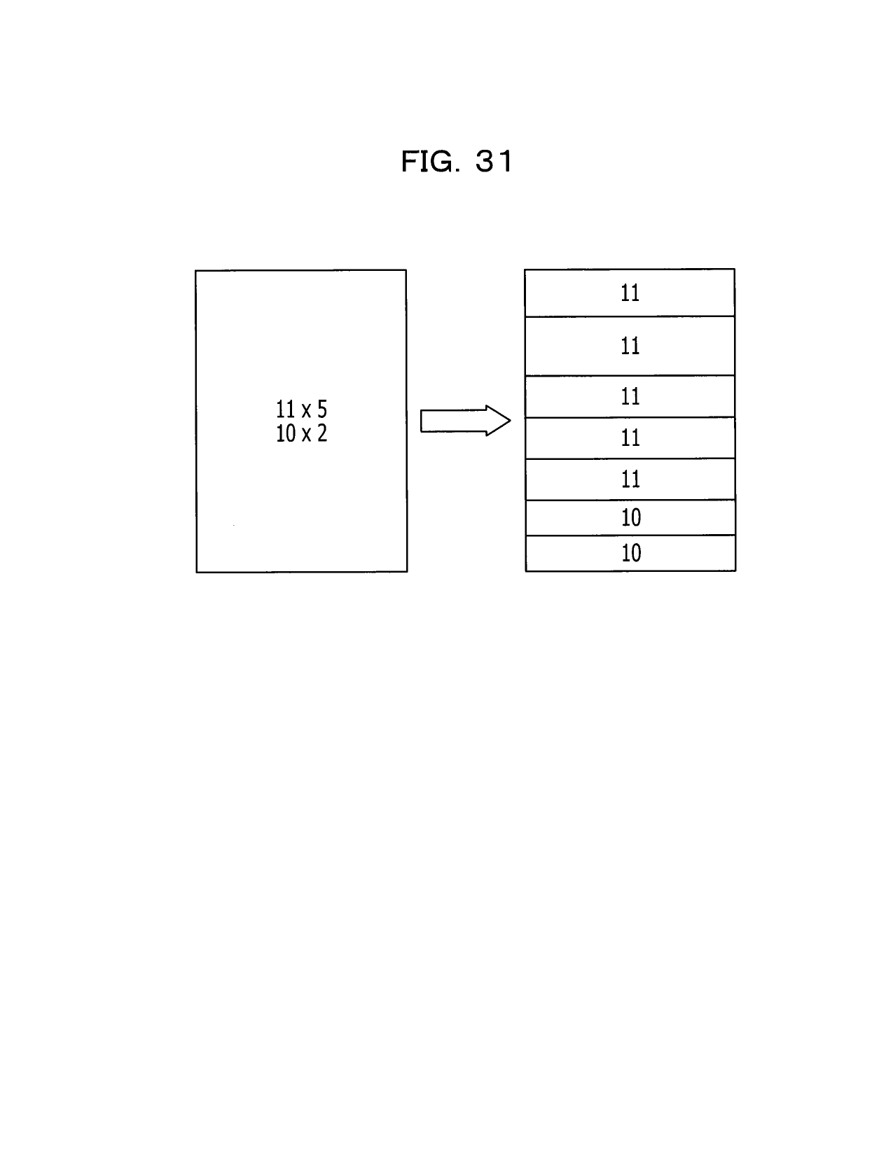

FIG. 31 is an explanatory diagram illustrating a notation example of uniform splitting. The region depicted in the left of FIG. 31 represents “11×5, 10×2”, which indicates five regions with 11 points of point data and two regions with 10 points of point data. Therefore, this indicates that the left region is actually subjected to uniform splitting as with the right region.

In FIG. 32, splitting number splitNum, is determined such that splitting number splitNum=4 by Route 2 (see FIG. 17) of the splitting number determining sub-routine (step S1604) regarding the region R1. Therefore, the region R1 is uniformly split into three regions with nine points of point data and one region with eight points of point data.

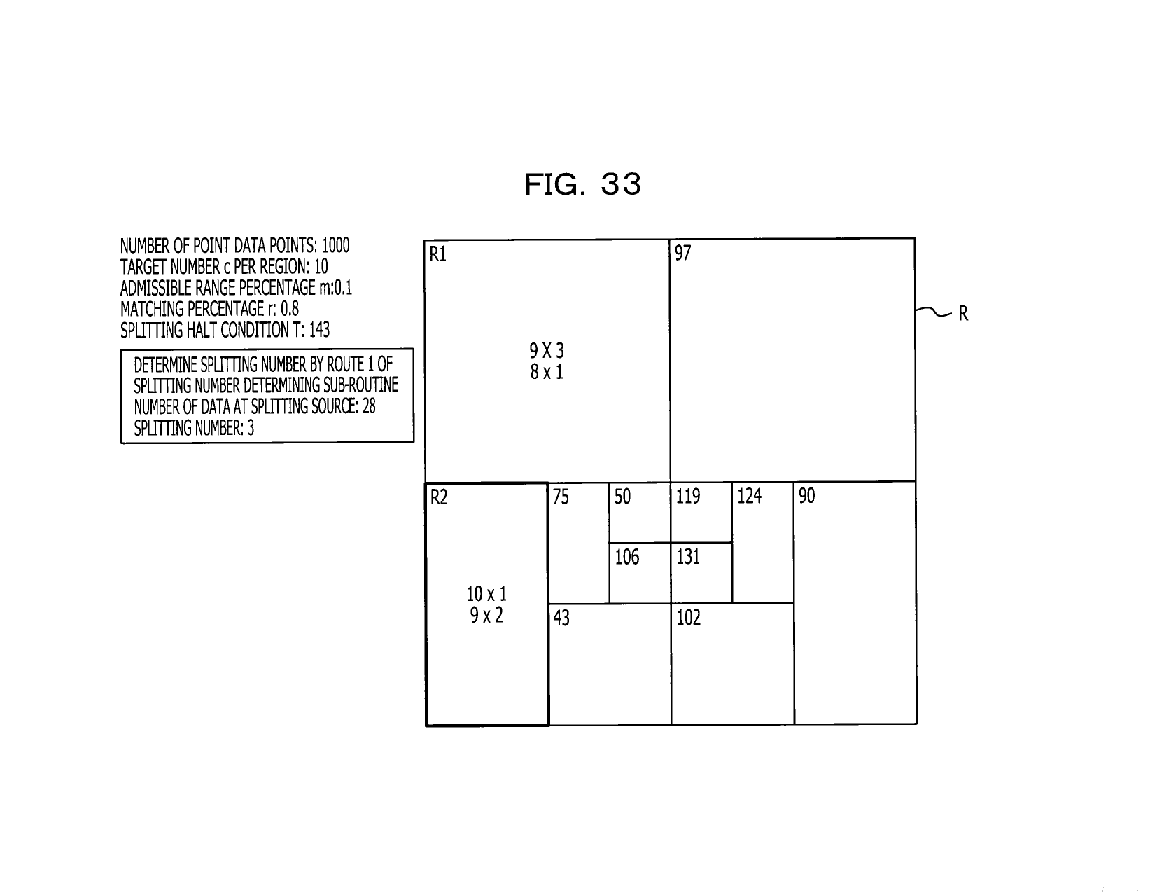

In FIG. 33, splitting number splitNum, is determined to splitting number splitNum=3 by Route 1 (see FIG. 17) of the splitting number determining sub-routine (step S1604) regarding the region R2. Therefore, the region R2 is uniformly split into one region with ten points of point data and two regions with nine points of point data.

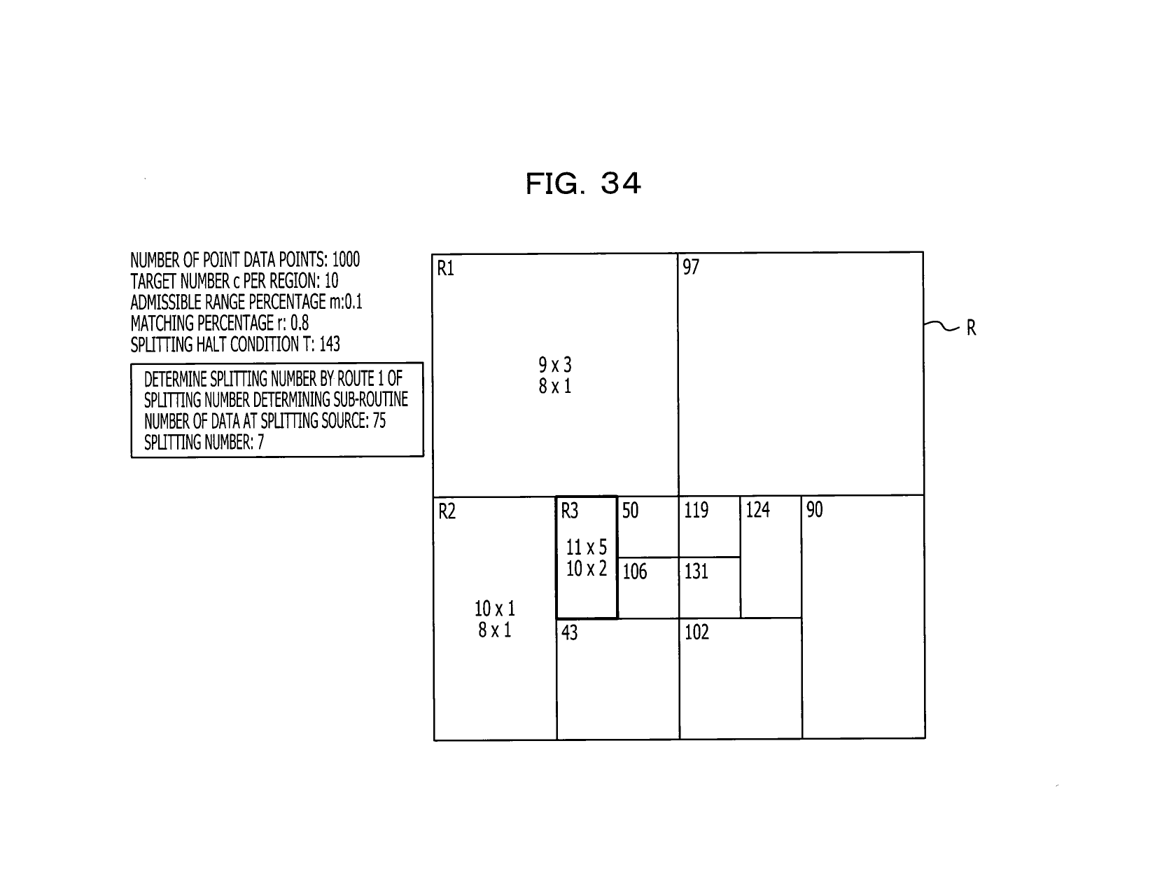

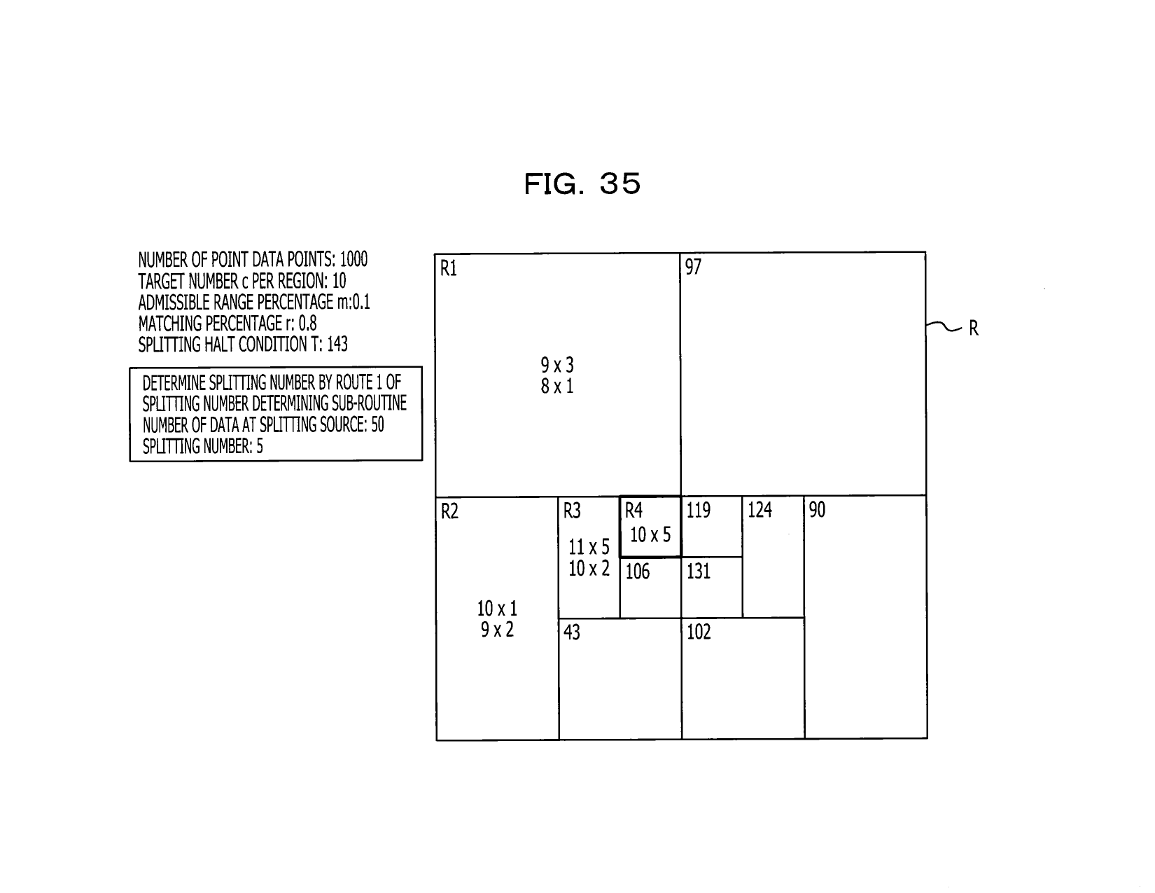

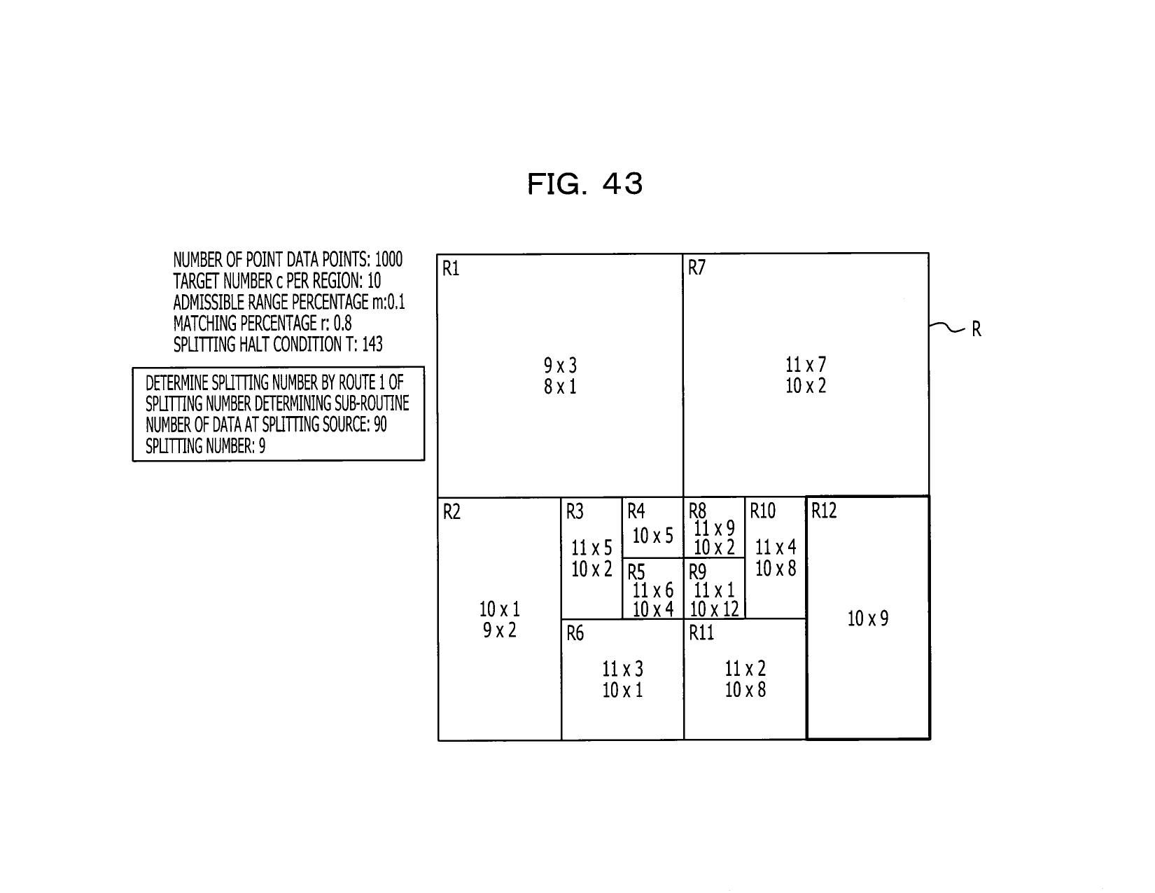

In FIG. 34, splitting number splitNum, is determined to splitting number splitNum=7 by Route 1 (see FIG. 17) of the splitting number determining sub-routine (step S1604) regarding the region R3. Therefore, the region R3 is uniformly split into five regions with 11 points of point data and two regions with ten points of point data. Hereinafter, in FIGS. 35 through 43 as well, uniform splitting is performed similar to the regions R4 to R12. In FIG. 43, uniform splitting of all equally split regions R1 to R12 is completed.

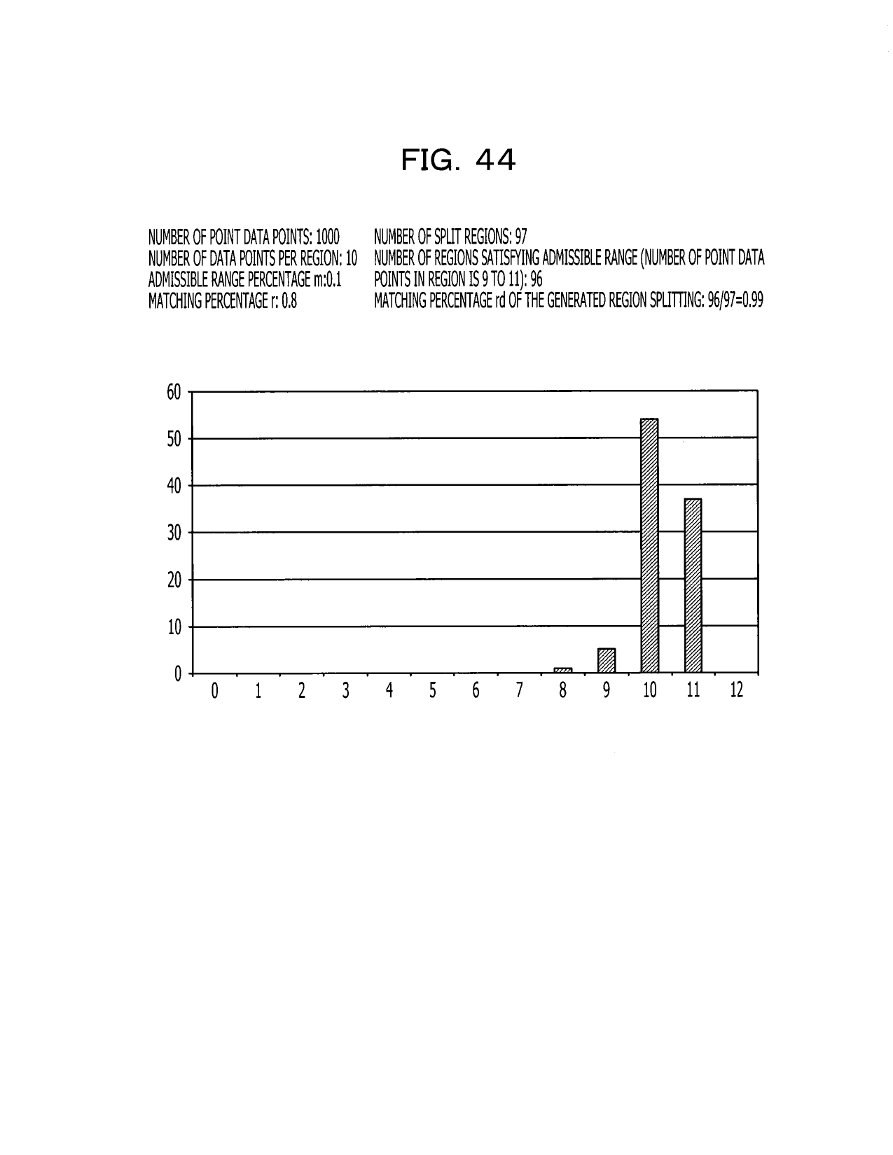

FIG. 44 is a histogram illustrating distribution of the point data in the region splitting result of FIG. 43. A lateral axis is the number of the point data points, and a longitudinal axis is the number of the regions. In this example, 96 regions where the number of the point data points is 9 to 11 satisfy admissible range percentage m=0.1. Also, the matching percentage rd of this example is rd=96/97=0.99 which exceeds the input matching percentage r=0.8. Therefore, region splitting of this example is illustrated to be appropriate region splitting. Note that, when matching percentage rd is less than the matching percentage r, the splitting device 700 may change the matching percentage r again and may perform region splitting.

The region splitting according to the present embodiment is applicable, for example, to various services including a fire station arrangement plan, a policeman stationing location arrangement plan, and an electricity supply system. In a fire station arrangement plan, fire outbreak spots and cases of people needing ambulances is taken as point data. When applied to the fire station arrangement plan, the arrangement of a certain city's fire stations is taken into consideration. Region splitting according to the present embodiment is performed, regarding a region having a point data group which is fire outbreak spots and the number of cases of people needing ambulances during the past several months. In the case that there is no fire station at the center or neighborhood of the region, the center or neighborhood are provided as a new arrangement position of a fire station in each region obtained by splitting.

In the policeman stationing location arrangement plan, crime scenes are taken as point data. When applying to the policeman stationing location arrangement plan, the placement of a certain city's policeman stationing locations is taken into consideration. Region splitting according to the present embodiment is performed, regarding a region having point a data group which is crime scenes during the past several months. In the case that there is no policeman stationing location at the center or neighbor of the region, the center or neighbor are provided as a new arrangement position of a policeman stationing location in each region obtained by splitting.

In the electricity supply system, the position of the movable bodies such as automobiles or portable terminals which people carry is point data and the battery charge of the movable bodies is attribute information. The point data and attribute information of the movable bodies are accessible by GPS. In the electricity supply system with the radio, the number of terminals which may transmit a message once is decided, and electricity is preferably supplied so that there is no electric power loss. In this case, such splitting is performed that a certain number of movable bodies are included using region splitting according to the present embodiment, and electricity is supplied with priority to a region where the sum of battery charge of the movable bodies in the split region is the smallest. Thereby, efficient electricity supply is implemented.

As described above, the splitting device according to the present embodiment performs equal splitting on a region having a group of point data points until it is below the equal splitting halt condition T, determines the splitting number for the final uniform splitting by the number of point data points in each region after uniform splitting, and finally performs uniform splitting once. Thereby, the longest distance between the point data in each uniformly split region shortens and the number of the point data points is uniformed. Thus, the longest distance between the point data in each uniformly split region shortens, so variance of the split area size may be suppressed, and situations where the region to be analyzed spreads over multiple areas may be reduced. Also, the number of the point data points in each uniformly split region is equalized, so variance of the number of the point data points in each uniformly split region is suppressed, and a misanalysis produced by a variance is reduced. Therefore, the splitting device according to the present embodiment may improve the convenience of the split region group.

Also, a region after the equal splitting may be equally split to a region satisfying admissible range percentage m by setting equal splitting halt condition T by greatest number of uniform divisions k satisfying kc(1+m)≧(k+1)c(1−m). That is to say, even if a region which has been equally split until it is less than the equal splitting halt condition T is subjected to uniform splitting, the number of the point data points in the region after the equal splitting will fit in a section defined by the admissible range percentage m of the target number c.

Also, equal splitting is performed so that the region percentage where the number of the point data points in the region as to the region group after the uniform splitting satisfies admissible range percentage m satisfies matching percentage r by using matching percentage r at the time of setting of the equal splitting halt condition T. Therefore, the user may obtain a region splitting result according to matching percentage r which the user permits.

Also, when performing equal splitting, the longest distance between the point data in the equally split region may be shortened by splitting equally so that the longest side of the target region of equally splitting is shortened.

Also, a region after the equal splitting may be split to the region where the number of the point data points is the number of greatest equal number of divisions k or less uniformly when the number of the point data points in the region after the equal splitting is within the section defined by admissible range rate m. Thereby, regions of the number of uniform splitting, which satisfy the admissible range percentage m, are generated.

Also, in the event that the number of the point data points in the region after the equal splitting is out of the section defined by admissible range percentage m, deterioration in uniform splitting precision can be suppressed by determining the splitting number of uniform splitting to be an integer where the number of point data points following the uniform splitting is close to the target number. Also, with the splitting number, there are two integer candidates (one or more integers) across the target number c, and determining a candidate which is nearer to the target number c may suppress deterioration in uniform splitting precision.

Also, variance of the number of the point data points between the uniformly split regions is suppressed by uniformly splitting so that difference of the number of the point data points in each uniformly split region is minimized. That is to say, the number of point data points between the uniformly split regions will be the same and may realize uniformity of the number of the point data points in the uniformly split region.

Also, the user may confirm the reliability of the region splitting result after the uniform splitting by calculating matching percentage rd after uniform splitting. Also, the user may confirm the reliability of the region splitting result after the equal splitting objectively by comparing with matching percentage rd when there is input matching percentage r.

Note that, the splitting method described in the present embodiment may be implemented by executing a program prepared beforehand by a computer such as a personal computer or workstation. This splitting program is recorded in a computer-readable recording medium, such as a hard disk, a flexible disk, a CD-ROM, MO, DVD or the like, and is executed by a computer by being read from the recording medium.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A splitting device comprising:
a memory configured to store a program including a procedure; and
a processor configured to execute the program, the procedure including:
first setting a halt condition with a number of point data points to halt equal splitting as to a target region for equal splitting to split equally, based on a target number of point data points to be included in each region after uniform splitting to split the region, so that the numbers of the point data points indicating locations are uniform, an admissible range percentage indicating an admissible range of the target number, and a greatest uniform splitting number which is a greatest splitting number after uniform splitting when performing uniform splitting of the region so as to satisfy the admissible range percentage;
splitting the target region for equal splitting, until the number of point data points in the target region for equal splitting is less than the set halt condition, by taking the target region for equal splitting, as a region where a point data group exists;
second setting a region having point data of a number or more according to the halt condition obtained by performing the splitting, to the target region for equal splitting;
performing the uniform splitting regarding each region group having less point data than the number according to the halt condition obtained by performing the splitting; and
outputting information regarding the split region group.

2. The splitting device according to claim 1, wherein
the first setting includes, in the event that a first integer exists such that an upper value of a first section defined by the admissible range percentage based on a first value where the target number has been multiplied by the first integer is equal to or smaller than a lower value of a second section defined by the admissible range percentage based on a second value where the target number has been multiplied by a second integer which is greater than the first integer, setting the first integer to the greatest uniform splitting number, and setting the halt condition based on this greatest uniform splitting number.

3. The splitting device according to claim 2, wherein
the first setting includes setting the greatest uniform splitting number using matching percentage indicating a percentage of the region where there exists the number of point data points satisfying the admissible range percentage, and setting the halt condition based on the greatest splitting number.

4. The splitting device according to claim 1, wherein
the second setting includes performing splitting of the target region for equal splitting, so as to shorten the longest side of the target region.

5. The splitting device according to claim 1, the procedure further comprising:
determining an integer which is an integral multiple of the target number, in the event that the number of point data points in the region is a number in a section defined by admissible range percentage based on the integral multiple of the target number, regarding each region of the region group obtained by the second setting,
wherein the performing of the uniform splitting includes
performing uniform splitting of each target region of the target region group for uniform splitting obtained by the second setting, by the splitting number determined regarding the each target region.

6. The splitting device according to claim 5, wherein
the determining includes
determining, out of a target region group of uniform splitting obtained by the second setting, regarding a specific target region which is not of a number within a section defined by an admissible range percentage based on the integral multiple of a target number, an integer in a case of obtaining a splitting result for one of a first splitting result out of a section smaller than the target number when splitting the number of point data points which the specific target region has by a third integer, and a second splitting result out of a section greater than the target number when splitting the number of point data points which the specific target region has by a fourth integer, to be a splitting number for uniform splitting.

7. The splitting device according to claim 6, wherein
the determining includes
determining, of the first splitting result and the second splitting result, an integer corresponding to the splitting result closer to the target number, to be the splitting number for uniform splitting.

8. The splitting device according to claim 5, the procedure further comprising:
determining, based on a division result where the number of point data points which a target region for uniform splitting has is divided by the splitting number, the number of point data points in each region regarding which the target region for uniform splitting has been uniformly split by the splitting number so that the difference of the numbers is minimum,
wherein the performing of the uniform splitting includes
performing uniform splitting regarding a target region for uniform splitting, so that each region following uniform splitting is a region where the number of point data points determined by a region data number determining unit exists.

9. The splitting device according to claim 1, the procedure further comprising:
calculating a matching percentage relating to the region group, based on the number of regions in the split region group and the number of regions where, of the split region group, the number of point data points satisfies the admissible range percentage;
wherein the outputting includes outputting the calculated matching percentage.

10. The splitting device according to claim 1, wherein
each of the point data points has attribute information.

11. A splitting method by a computer, the method comprising:
first setting a halt condition with a number of point data points to halt equal splitting as to a target region for equal splitting to split equally, based on a target number of point data points to be included in each region after uniform splitting to split the region so that the numbers of the point data points indicating locations are uniform, an admissible range percentage indicating an admissible range of the target number, and a greatest uniform splitting number which is the greatest splitting number after uniform splitting when performing uniform splitting on the region so as to satisfy the admissible range percentage;
splitting the target region for equal splitting, until the number of point data points in the target region for equal splitting is less than the set halt condition, by taking the target region for equal splitting which is stored in a storage device, as a region where a point data group exists;
second setting a region having point data of a number or more according to the halt condition obtained by performing the splitting to the target region for equal splitting;
performing the splitting regarding each of the region group having less point data than the number according to the halt condition; and
outputting information regarding the uniformly split region group.

12. The splitting method according to claim 11, wherein
the first setting includes, in the event that a first integer exists such that an upper value of a first section defined by the admissible range percentage based on a first value where the target number has been multiplied by the first integer is equal to or smaller than a lower value of a second section defined by the admissible range percentage based on a second value where the target number has been multiplied by a second integer which is greater than the first integer, setting the first integer to the greatest uniform splitting number, and setting the halt condition based on this greatest uniform splitting number.

13. The splitting method according to claim 12, wherein
the first setting includes setting the greatest uniform splitting number using matching percentage indicating a percentage of the region where there exists the number of point data points satisfying the admissible range percentage, and setting the halt condition based on the greatest splitting number.

14. The splitting method according to claim 11, wherein
the second setting includes performing splitting of the target region for equal splitting, so as to shorten the longest side of the target region.

15. The splitting method according to claim 11, further comprising:
determining an integer which is an integral multiple of the target number, in the event that the number of point data points in the region is a number in a section defined by admissible range percentage based on the integral multiple of the target number, regarding each region of the region group obtained by the second setting,
wherein the performing of the uniform splitting includes
performing uniform splitting of each target region of the target region group for uniform splitting obtained by the second setting, by the splitting number determined regarding the each target region.

16. The splitting method according to claim 15, wherein
the determining includes
determining, out of a target region group of uniform splitting obtained by the second setting, regarding a specific target region which is not of a number within a section defined by an admissible range percentage based on the integral multiple of a target number, an integer in a case of obtaining a splitting result for one of a first splitting result out of a section smaller than the target number when splitting the number of point data points which the specific target region has by a third integer, and a second splitting result out of a section greater than the target number when splitting the number of point data points which the specific target region has by a fourth integer, to be a splitting number for uniform splitting.

17. The splitting method according to claim 16, wherein
the determining includes
determining, of the first splitting result and the second splitting result, an integer corresponding to the splitting result closer to the target number, to be the splitting number for uniform splitting.

18. The splitting method according to claim 15, further comprising:
determining, based on a division result where the number of point data points which a target region for uniform splitting has is divided by the splitting number, the number of point data points in each region regarding which the target region for uniform splitting has been uniformly split by the splitting number so that the difference of the numbers is minimum,
wherein the performing of the uniform splitting includes
performing uniform splitting regarding a target region for uniform splitting, so that each region following uniform splitting is a region where the number of point data points determined by a region data number determining unit exists.

19. The splitting method according to claim 11, further comprising:
calculating a matching percentage relating to the region group, based on the number of regions in the split region group and the number of regions where, of the split region group, the number of point data points satisfies the admissible range percentage;
wherein the outputting includes outputting the calculated matching percentage.

20. A computer-readable recording medium storing a program for causing an apparatus to execute a procedure, the procedure comprising:
setting a halt condition with a number of point data points to halt equal splitting as to a target region for equal splitting to split equally, based on a target number of point data points to be included in each region after uniform splitting to split the region so that the numbers of the point data points indicating locations are uniform, an admissible range percentage indicating an admissible range of the target number, and a greatest uniform splitting number which is the greatest splitting number after uniform splitting when performing uniform splitting on the region so as to satisfy the admissible range percentage;
splitting the target region for equal splitting, until the number of point data points in the target region for equal splitting is less than the set halt condition, by taking the target region for equal splitting which is stored in a storage device, as a region where a point data group exists;
setting a region having point data of a number or more according to the halt condition obtained by performing the splitting to the target region for equal splitting;
performing the splitting regarding each of the region group having less point data than the number according to the halt condition; and
outputting information regarding the uniformly split region group.
